(19) United States
(12) Patent Application Publication
(10) Pub. No.: US 2025/0338342 A1
(43) Pub. Date: Oct. 30, 2025

(54) DIRECT DEVICE SERVICE BASED INTERFACE ACCESS TO A CORE NETWORK

(71) Applicant: InterDigital Patent Holdings, Inc., Wilmington, DE (US)

(72) Inventors: Ulises Olvera-Hernandez, Saint-Lazare (CA); Antonio de la Oliva, Madrid (ES); Robert Gazda, Spring City, PA (US); Samir Ferdi, Kirkland (CA)

(73) Assignee: InterDigital Patent Holdings, Inc., Wilmington, DE (US)

(21) Appl. No.: 18/646,428

(22) Filed: Apr. 25, 2024

(51) Int. Cl. H04W 76/20; H04W 12/0431; H04W 48/20

(52) U.S. Cl. CPC H04W 76/20; H04W 12/0431; H04W 48/20

(57) ABSTRACT

One or more systems, devices, and/or methods for direct device service-based interface (SBI) access to a core network, or its equivalent, are described herein. For example, SBI communication may be used to facilitate communication with one or more network elements between one or more wireless transmit receive units (WTRU). This communication may include all aspects of a device to network communication, such as system level procedure(s) for SBI WTRU communication establishment, radio access network (RAN) node discovery and selection procedure for SBI WTRU access, SBI WTRU connection establishment with no SBI WTRU RAN security, SBI WTRU connection establishment with SBI WTRU RAN security, SBI WTRU connection establishment with SBI WTRU RAN security and key infrastructure assistance, and/or SBI higher-layer secure SBI communication via an SBI gateway.

### BACKGROUND

In 3GPP systems, a mobile device may communicate with an Access and Mobility Management Function (AMF) as part of a 5G (5th Generation) mobile network architecture. The AMF in the 5G core network (5GC) is responsible for access and mobility management functions. There is a need to move beyond AMF only systems, and explore architectures (e.g., and their resulting procedures, devices, systems, etc.) that either improve on or replace existing architectures to address future use demands.

### SUMMARY

One or more systems, devices, and/or methods for direct device service-based interface (SBI) access to a core network, or its equivalent, are described herein. For example, SBI communication may be used to facilitate communication with one or more network elements between one or more wireless transmit receive units (WTRU). This communication may include all aspects of a device to network communication, such as system level procedure(s) for SBI WTRU communication establishment, radio access network (RAN) node discovery and selection procedure for SBI WTRU access, SBI WTRU connection establishment with no SBI WTRU RAN security, SBI WTRU connection establishment with SBI WTRU RAN security, SBI WTRU connection establishment with SBI WTRU RAN security and key infrastructure assistance, and/or SBI higher-layer secure SBI communication via an SBI gateway.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a diagram illustrating an example communications system in which one or more disclosed embodiments may be implemented.

FIG. 1B is a system diagram illustrating an example WTRU.

FIG. 1C is a system diagram illustrating the RAN and the CN according to an embodiment.

FIG. 1D is a system diagram illustrating the RAN and the CN according to an embodiment.

FIG. 2 illustrates an example of a roaming system architecture service based interface (SBI) representation.

FIG. 3 illustrates an example of an initial access procedure.

FIG. 4 illustrates an example of a key hierarchy generation for a given wireless system.

FIG. 5 illustrates an example of SBI WTRU communication establishment.

FIG. 6 illustrates an example of SBI WTRU access RAN node selection.

FIG. 7 illustrates an example of system information block 1.

FIG. 8 illustrates an example of SBI WTRU connection establishment with no security.

FIG. 9 illustrates an example of an enhanced RRCSetupRequest message.

FIG. 10 illustrates an example of enhanced RRCSetup message.

FIGS. 11A and 11B (collectively referred to as FIG. 11) illustrates an example of an enhanced RRCSetupComplete.

FIGS. 12A and 12B (collectively referenced as FIG. 12), may illustrate an example of an Enhanced RRCReconfiguration message.

FIG. 13 illustrates an example of a PDCP-config information element.

FIG. 14 illustrates an example of SBI WTRU security information element.

FIG. 15 illustrates an example of a SBI WTRU connection establishment with SBI WTRU RAN security.

FIG. 16 illustrates an example of an enhanced securitymodecommand.

FIG. 17 illustrates an example of a securitymodecomplete.

FIG. 18 illustrates an example of an enhanced SBI-WTRU-security IE considering KI.

FIG. 19 illustrates an example of SBI WTRU connection establishment with SBI WTRU RAN security and key infrastructure.

FIG. 20 illustrates an example method according to one or more techniques described herein.

### DETAILED DESCRIPTION

One or more of the following acronyms/abbreviations may be used herein: 5GC (5G Core), 5GS (5G System), 6GC (6G Core), 6GS (6G System), AF (Application Function), AKA (Authentication and Key Agreement), AMF (Access and Mobility Management Function), AN (Access network), AP (Access Point), APN (Access Point Name), AS (Application Server), AUSF (Authentication Server Function), CN (Core network), CNF (Cloud Native network Function), CPN (Customer Premise network), CU (Centralized Unit), DN (Data network), DNN (Data network Name), DRB (Data Radio Bearer), DU (Distributed Unit), HTTP (Hyper Text Transfer Protocol), IP (Internet Protocol), IPSec (IP security), L1 (Layer 1), L2 (Layer 2), MNO (Mobile network Operator), NAS (Non-Access Stratum), NEF (network Exposure Function), NPN (Non-Public network), NR (New Radio), NRF (network Repository Function), OS (Operating System), PCF (Policy Control Function), PDU (Protocol Data Unit), PLMN (Public Land Mobile network), PSA (PDU Session Anchor), PSAS (PDU Session Anchor Selection Service), PUC (PSA UPF Connection), QFI (QOS Flow Identifier), QoS (Quality of Service), RAN (Radio Access network), RRC (Radio Resource Control), SBA (Service-based Architecture), SBI (Service Base Interface), SDAP (Service Data Adaptation Protocol), SGW (SBI Gateway), SIB (System Information Block), SRB (Signaling Radio Bearers), SUCI (Subscription Concealed Identifier), SUPI (Subscription Permanent Identifier), TE (Terminal Equipment), TLS (Transport Layer security), UE (User Equipment), UPF (User Plane Function), UPF-C (UPF Control Plane Part), UPF-D (UPF Data Plane Part), URSP (UE Route Selection Policy), WLAN (Wireless Local Area networks and related technologies, IEEE 802.xx domain).

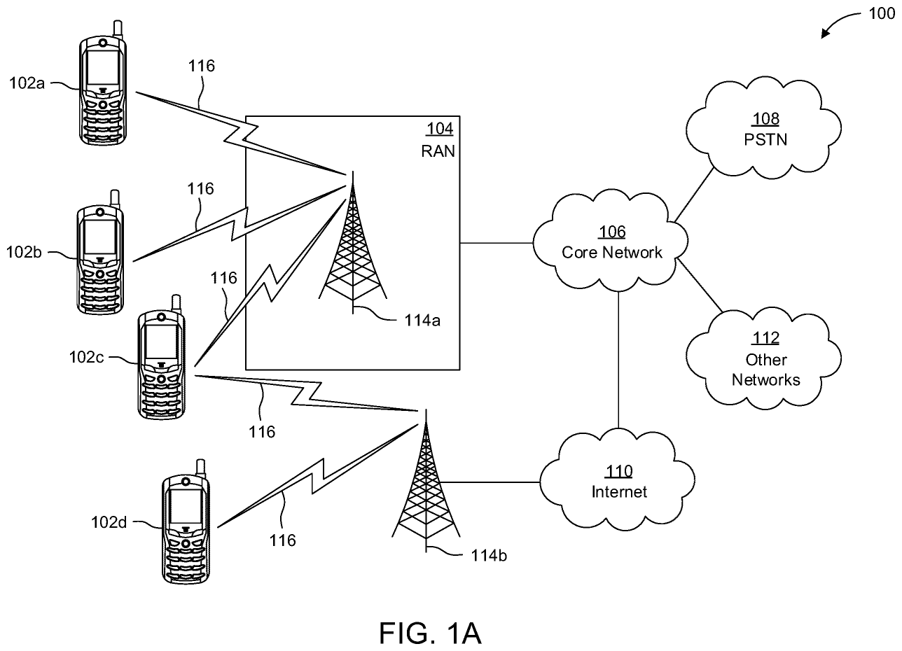

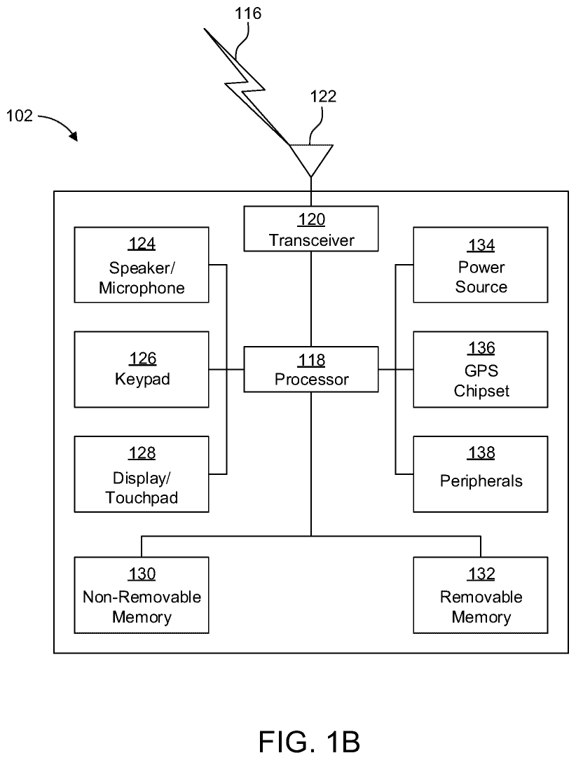

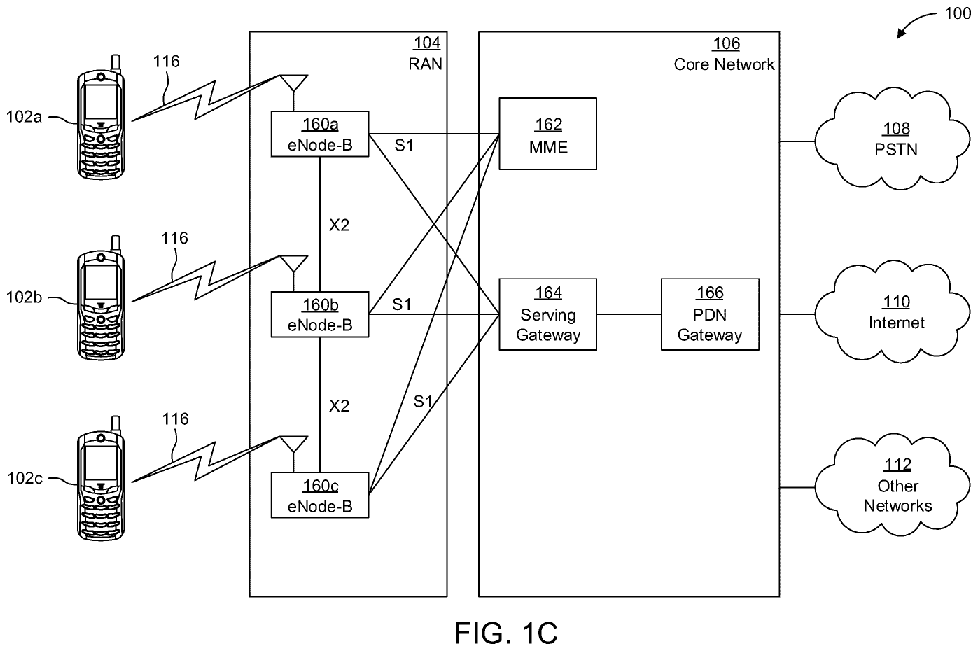

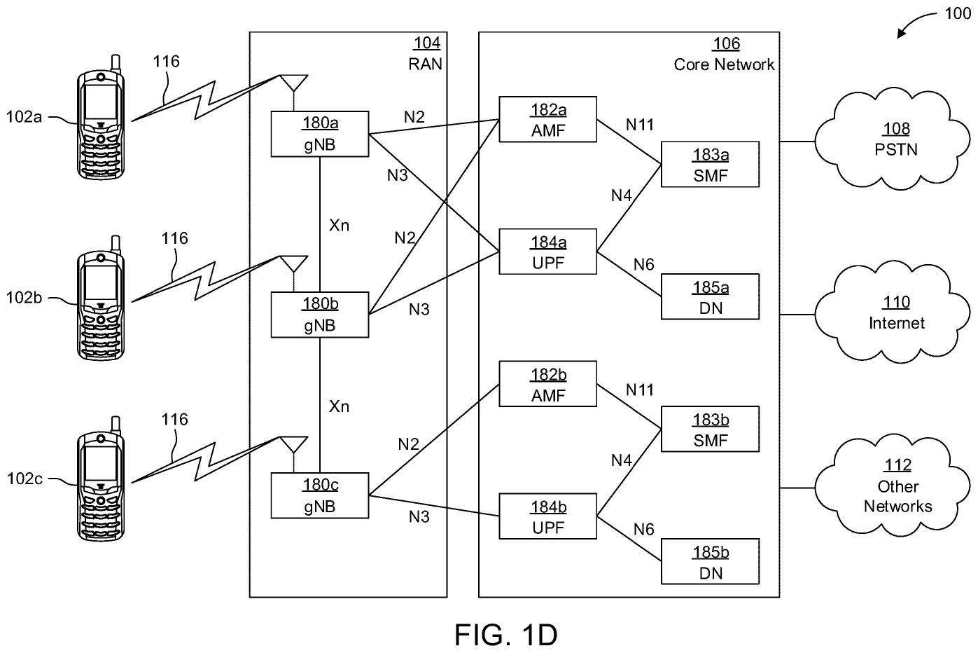

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like. Note, for all figures described herein, it is intended for illustration purposes only, and it is also intended that all elements or steps illustrated in a figure may be optional and are not intended to be required.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, RAN node, a site controller, an access point (AP), a wireless router, and the like (where all these terms may be interchangeable). While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include an AMF 182a, 182b, UPF 184a, 184b, Session Management Function (SMF) 183a, 183b, and possibly a Data network (DN) 185a, 185b. While the foregoing elements are depicted as part of the CN 106, it will be appreciated that any of these elements may be owned and/or operated by an entity other than the CN operator. As discussed herein, any reference to function may be interchangeable with element (e.g., Network Function may be equivalent to a Network Element).

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, emulation devices may be utilized in a testing scenario in a testing laboratory and/or a non-deployed (e.g., testing) wired and/or wireless communication network in order to implement testing of one or more components. The one or more emulation devices may be test equipment. direct RF coupling and/or wireless communications via RF circuitry (e.g., which may include one or more antennas) may be used by the emulation devices to transmit and/or receive data.

As described herein, an access network or radio access network may provide wireless, or other connectivity, to a network. Access network and RAN may be used interchangeably. Access networks may include but are not limited to 3G, 4G, 5G, 6G, WiFi, etc.

As described herein, a Core network (CN) is composed of network elements that provide services, functions, or other capabilities to devices or network elements. CN examples include: a 5G Core network, a 6G Core network, a Data network, an Enterprise network, or a Cloud/Edge network, etc.

As described herein, a network element is an entity within the network that provides some functionality and can be accessed with a SBI interface. A network element may be a network Function (NF, such as in a 5GS or 6GS), an Application Function (AF), a Service or Service Enabler, a Cloud or Edge Server, or any other server or service. A network element may reside in a Core network or on another WTRU that can be accessed via a RAN (included device-to-device connection). “network element” and “element” are used interchangeably in this document.

As described herein, a RAN node is a point of access within a RAN (for example gNB, eNB, 6G point of access, WiFi Access Point (AP), etc.).

As described herein, a SBI Gateway (SGW) is in the network that serves as an entry point for SBI messages from a WTRU. Some network deployments may or may not include an SGW.

As described herein, a WTRU (user equipment) is a terminal device that connects to an access network.

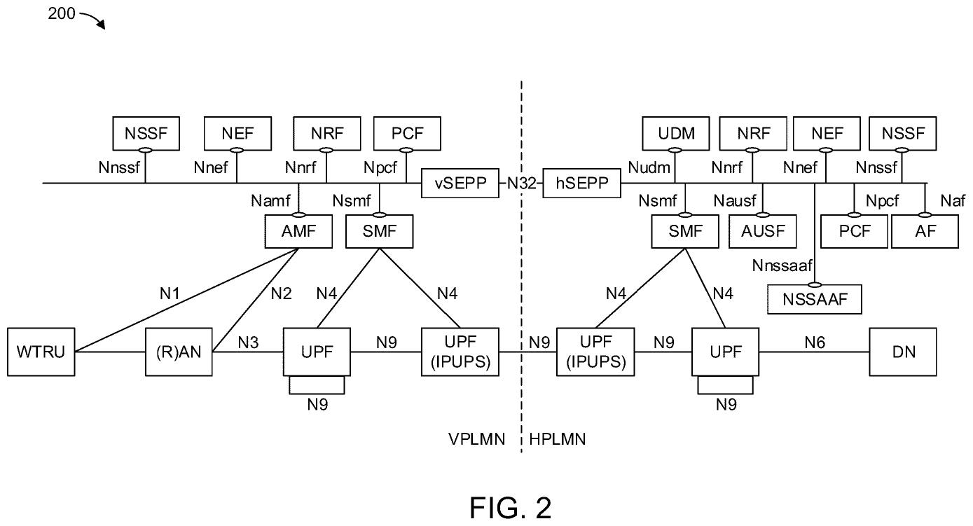

FIG. 2 illustrates an example of a roaming system architecture service-based interface (SBI) representation. Note, this example illustrates a scenario where the WTRU still accesses the network not through an SBI (e.g., to this point, there may be one or more approaches described further herein, where the WTRU may access network elements/functions directly through an SBI).

In some 3GPP system architectures, (e.g., the 4G Evolved Packet Core network, etc.) entities (e.g., the Mobility Management Entity-MME) may be split into smaller software functional components known as network Functions (NFs) based on monolithic software components providing multiple services. This splitting enables the implementation of a Service-based Architecture (SBA), with NFs providing services with specific functionality and scope. These services are enabled through the definition of Service-based Interfaces (SBIs) for their communication among service producers and service consumers.

Furthermore, in some instances the communication pattern amongst NFs, utilize HTTP/2 as their application layer protocol, which enables 5G Core (5GC) NFs to be microservices following a 12-factor app software engineering paradigm.

Some NFs (e.g., 5G) may provide specific services that are enabled using SBI interfaces, but for some exceptions such as those interfaces connected to the Core network with the WTRU (e.g., UE) and connecting the Core network with the Radio Access network, and the interface between the Session Management Function (SMF) and the User Plane Function (UPF).

Thus, SBIs are distinctively named from non-SBIs in the system architecture, FIG. 2, where for example non-SBI-enabled interfaces start with N followed by a number (e.g., N1) while SBI-enabled interfaces start with N followed by the NF's acronym (e.g., Namf) that clearly indicates the service the NF provides.

Generally, SBIs are interfaces that facilitate communication between different network functions within a service-based architecture. SBIs define standardized protocols and procedures for interactions between network functions, enabling the deployment of services across heterogeneous network environments. These interfaces play a crucial role in implementing service-based architectures, which aim to improve flexibility, scalability, and interoperability within telecommunications networks.

When realizing SBI-enabled NFs (e.g., for 5GC, etc.) as microservices the provisioning of NFs as Cloud Native network Functions (CNFs) becomes a valuable proposition. Microservices are characterized by a software engineering paradigm, which may be referred to as the 12-factor app methodology. Generally, this methodology is a set of best practices for building/implementing cloud-native applications. This methodology allows the disintegration of monolithic software components into a set of mainly stateless microservices that externalize any functionality that is not related to the purpose of the microservice itself, such as logging, keeping state or balancing request to cope with an increase of requests, etc. The advantage of CNFs is the ability to orchestrate (e.g., as in provision and lifecycle manage CNFs) microservices across a range of compute hosts and externalizing the ability to scale them up/down or out/in through automated procedures. This concept is referred to as “cloud native” which may be applied to SBI-enabled NFs, as described herein. However, it may be noted that not all interfaces of 3GPP's system architecture on the control plane are SBI-enabled.

In contrast to cloud native systems, with RESTful interfaces, in some approaches (e.g., early 5G systems), a non-access stratum (NAS) application or client in a WTRU is designed to route all messages, regardless of their nature (e.g., mobility management or session management) to a central “anchor” point (e.g., the 5GC NF AMF), where all other message types need to go through, even if they are intended for a server providing a different functionality from what the “anchor” server may provide, unlike a typical service-based application, that rely on RESTful interfaces. While this approach is operational and provides some advantages, it is possible in certain circumstances this may act as a bottleneck, and present problems.

Furthermore, the NAS client may neither contact specific NFs within the 3GPP CN Server directly, nor choose which server to route messages, since routing of NAS messages is constraint by the Access network processing 3GPP NAS messages, and this is regardless of what Access network is used (e.g., 3GPP or Non-3GPP).

The reason for this behavior is that the NAS is used as a transport protocol for several of the key operations performed by the WTRU, such as registration onto the network. Generally, NAS signaling handles communication between the WTRU and the core network (CN) for control plane signaling (e.g., mobility management, session management, security, authentication, etc. independent of radio access technology). These processes are tightly coupled with the network security mechanisms, therefore services such as registration have not used an SBI approach in the past, since the WTRU is not able to set up a communication with the network before registering.

In one example, there may be an initial access procedure. Generally, a WTRU initiates the connection process by sending an RRCSetupRequest message to the gNB-DU, containing a random WTRU identity and an establishment cause. If the WTRU is admitted, the gNB-DU includes the RRC message and low layer configuration in the INITIAL UL RRC MESSAGE TRANSFER message and transfers it to the gNB-CU. The gNB-CU then allocates a gNB-CU WTRU F1AP ID and sends a RRCSetup message encapsulated in the DL RRC MESSAGE TRANSFER message to the WTRU. Once received, the WTRU sends an RRC setup complete message with a Registration Request (e.g., NAS message, which is different than the RRC messages) to the gNB-DU. Subsequent steps involve NAS protocol and RRC layer interactions, including WTRU identity requests, NAS authentication, and security mode commands. The AMF sends an INITIAL CONTEXT SETUP REQUEST message to the gNB-CU, which sets up the WTRU context. Finally, the gNB-DU sends RRCReconfiguration messages to the WTRU, which responds with RRCReconfigurationcomplete messages. These exchanges continue until the WTRU context is established, confirmed by messages sent between the gNB-CU and the AMF. Note, in this example it is assumed that the RAN node (e.g., base station) is split between a CU and a DU, however, it is intended that the techniques discussed herein where such a split is described an alternative case may exists that does not have a split; meaning, it is intended that the techniques discussed herein apply to non-split RAN nodes, as if the CU and DU are integrated.

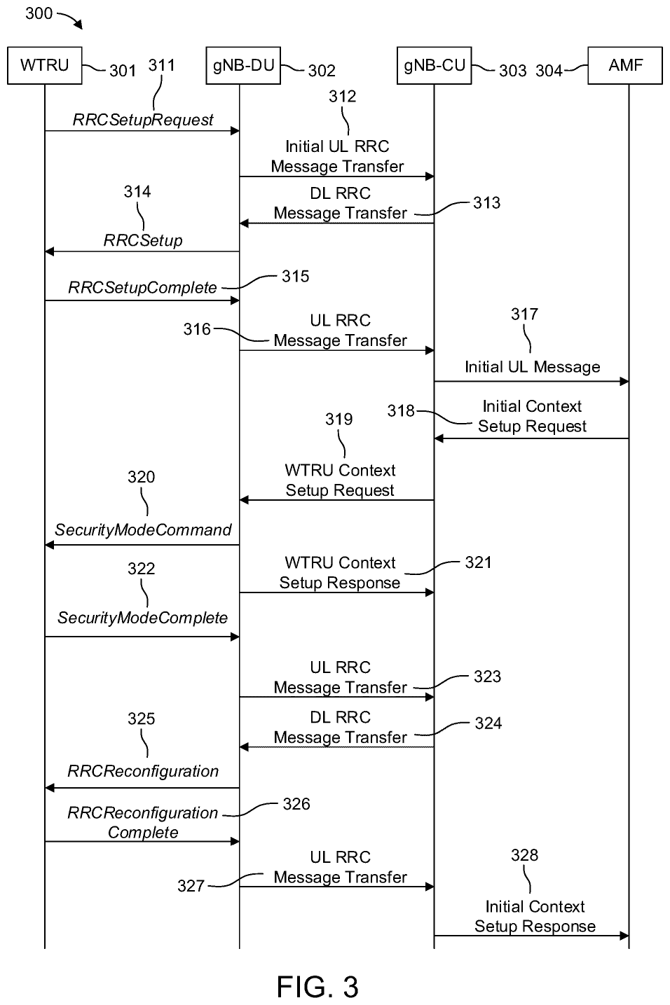

FIG. 3 illustrates an example of an initial access procedure. As shown, there may be a WTRU 301, a gNB-DU 302, a gNB-CU 303, and an AMF 304. While this example is illustrated with specific types of devices/functions, it is intended that one or more steps of this procedure may be performed with one or more other devices/functions/entities as disclosed herein (e.g., FIG. 1A-D, or any other figure, description, etc.). Furthermore, it is intended that each step of this procedure may be modified, limited, and/or expanded to adapt to a SBI scenario, as further described herein.

Additionally/alternatively, at 311, the WTRU sends an RRCSetupRequest message to the gNB-DU. The RRC setup Request is sent with the random WTRU-Identity and an establishment cause, which may be selected from a list including Emergency call, Mobile terminated access, etc.

Additionally/alternatively, at 312, the gNB-DU includes the RRC message and, if the WTRU is admitted, the corresponding low layer configuration for the WTRU in the INITIAL UL RRC MESSAGE TRANSFER message and transfers to the gNB-CU. The INITIAL UL RRC MESSAGE TRANSFER message includes the C-RNTI allocated by the gNB-DU.

Additionally/alternatively, at 313, the gNB-CU allocates a gNB-CU WTRU F1AP ID for the WTRU and generates a RRCSetup message towards WTRU. The RRC message is encapsulated in -the DL RRC MESSAGE TRANSFER message.

Additionally/alternatively, at At 314, the gNB-DU sends the RRCSetup message to the WTRU. The RRC setup message is sent to setup SRB1 and the master cell. The message carries the radioBearerConfig and masterCellGroup information elements.

Additionally/alternatively, at 315, the WTRU sends the RRC setup complete message with a Registration Request in the dedicatedNAS-message field. Note this message shows a direct coupling between the NAS protocol and RRC layers, since the NAS PDU is encapsulated within a RRC message (RRCSetupComplete)

Additionally/alternatively, at 316, the gNB-DU encapsulates the RRC message in the UL RRC MESSAGE TRANSFER message and sends it to the gNB-CU.

Additionally/alternatively, at 317, the gNB-CU sends the INITIAL WTRU MESSAGE to the AMF. The gNB sends the Initial WTRU message to the selected AMF. The message carries the Registration Request that was received from the WTRU in the RRC setup complete message. The “RAN WTRU NGAP ID” and the “RRC Establishment Cause” are also included in the message. The AMF will use the “RAN WTRU NGAP ID” to address the WTRU context on the gNB. This message is regarded as the initial NAS message since no NAS security is in place. Therefore, this message is constrained to a set of IEs which can be sent in the clear. Once the NAS SA is setup, the NAS message encapsulated in this message will be cyphered and the whole Initial WTRU message integrity protected.

Between 317 and 318, there may be one or more steps where identities, authorization and security at NAS protocol level are performed. These include: the AMF requests the WTRU identity (SUCI) from the WTRU via the Identity Request NAS message; the WTRU responds to the Identity Request with SUCI in a NAS Identity Response message, where the SUCI is derived from the public key of the Home PLMN; after the AMF obtains the credentials and master key to derive NAS security keys and other security keys from the AUSF, AMF initiates NAS authentication; the AMF sends to the WTRU an Authentication Request, to initiate the authentication procedure with the WTRU, where the key selector, RAND and AUTN is sent to the WTRU; the WTRU responds to the authentication challenge with a NAS Authentication Response message; the AMF signals the selected NAS security algorithm to the WTRU through a NAS security mode command. The AMF also requests the IMEISV from the WTRU; and/or, the WTRU signals the completion of the NAS security procedure through a NAS security mode complete, where the message contains the IMEISV.

Additionally/alternatively, at 318, the AMF sends the INITIAL CONTEXT SETUP REQUEST message to the gNB-CU. The purpose of the Initial Context setup procedure is to establish the necessary overall initial WTRU Context at the NG-RAN node, when required, including PDU session context, the security Key, Mobility Restriction List, WTRU Radio Capability and WTRU security Capabilities, etc. The AMF initiates a session setup with the gNB. The message typically contains the Registration Accept NAS message. The message carries one or more PDU Session setup requests. Each PDU session is addressed with the “PDU Session ID”.

Additionally/alternatively, at 319, the gNB-CU sends the WTRU CONTEXT SETUP REQUEST message to establish the WTRU context in the gNB-DU. In this message, it may also encapsulate the securitymodecommand message. In case of NG-RAN sharing, the gNB-CU includes the serving PLMN ID (for SNPNs the serving SNPN ID).

Additionally/alternatively, at 320, the gNB-DU sends the securitymodecommand message to the WTRU. The securitymodecommand message is used to command the activation of AS security. The WTRU performs one or more of the following actions on receiving the security mode command: derive the K-gNB key; K-gNB is a key derived by WTRU and AMF from K-AMF; derive K-RRC-int key associated with the Integrity Protection Algorithm; verify the integrity protection of the security mode command message; derive K-UP-int key associated with the Integrity Protection Algorithm; and/or, start SRB Integrity Protect.

Additionally/alternatively, at 321, the gNB-DU sends the WTRU CONTEXT SETUP RESPONSE message to the gNB-CU.

Additionally/alternatively, at 322, the WTRU responds with the securitymodecomplete message. The securitymodecomplete message is used to confirm the successful completion of a security mode command. Ciphering will be enabled after sending this message. The security mode complete message is itself not ciphered. The message is however integrity protected.

Additionally/alternatively, at 323, the gNB-DU encapsulates the RRC message in the UL RRC MESSAGE TRANSFER message and sends it to the gNB-CU.

Additionally/alternatively, at 324, the gNB-CU generates the RRCReconfiguration message and encapsulates it in the DL RRC MESSAGE TRANSFER message.

Additionally/alternatively, at 325, the gNB-DU sends RRCReconfiguration message to the WTRU. The purpose of this message is to modify an RRC connection, e.g. to establish/modify/release RBs, to perform reconfiguration with sync, to setup/modify/release measurements, to add/modify/release SCells and cell groups. As part of the procedure, NAS dedicated information may be transferred from the network to the WTRU.

Additionally/alternatively, at 326, the WTRU sends RRCReconfigurationcomplete message to the gNB-DU. The RRC Reconfiguration complete message is used to confirm the successful completion of an RRC connection reconfiguration.

Additionally/alternatively, at 327, the gNB-DU encapsulates the RRC message in the UL RRC MESSAGE TRANSFER message and send it to the gNB-CU.

Additionally/alternatively, at 328, the gNB-CU sends the INITIAL CONTEXT SETUP RESPONSE message to the AMF. This message is sent by the NG-RAN node to confirm the setup of a WTRU context.

In one example, the gNB-DU and gNB-CU of FIG. 3 may be replaced with a base station. In one example, the gNB-DU and gNB-CU of FIG. 3 may be replaced with multiple base stations. In one example, the gNB-DU and gNB-CU of FIG. 3 may be replaced with a base station and at least one network node. In one example, the AMF of FIG. 3 may be replaced with one or more network functions/entities, as part of a service-based approach.

In one example, there may be one or more actions performed by a WTRU for initial access; the WTRU may interact with a base station that is split up into a central unit (CU) and a distributed unit (DU), which in turn may interact with a network function/entity and/or one or more network service-based interfaces (network). The WTRU sends an RRCSetupRequest message to the DU. The RRC setup Request is sent with the random WTRU-Identity and an establishment cause, which can be selected from a list including Emergency call, Mobile terminated access, etc. Next, the DU includes the RRC message and, if the WTRU is admitted, the corresponding low layer configuration for the WTRU in the INITIAL UL RRC MESSAGE TRANSFER message and transfers to the CU. The INITIAL UL RRC MESSAGE TRANSFER message includes the C-RNTI allocated by the DU. Next, the CU allocates a CU WTRU F1AP ID for the WTRU and generates a RRCSetup message towards WTRU. The RRC message is encapsulated in -the DL RRC MESSAGE TRANSFER message. Next, the DU sends the RRCSetup message to the WTRU. The RRC setup message is sent to setup SRB1 and the master cell. The message carries the radioBearerConfig and masterCellGroup information elements.

Additionally/alternatively, the WTRU sends the RRC setup complete message with a Registration Request in the dedicatedNAS-message field. Note this message shows a direct coupling between the NAS protocol and RRC layers, since the NAS PDU is encapsulated within a RRC message (RRCSetupComplete)

Additionally/alternatively, the DU encapsulates the RRC message in the UL RRC MESSAGE TRANSFER message and sends it to the CU.

Additionally/alternatively, the CU sends the INITIAL WTRU MESSAGE to the network. The base station sends the Initial WTRU message to the selected network. The message carries the Registration Request that was received from the WTRU in the RRC setup complete message. The “RAN WTRU NGAP ID” and the “RRC Establishment Cause” are also included in the message. The network will use the “RAN WTRU NGAP ID” to address the WTRU context on the base station. This message is regarded as the initial NAS message since no NAS security is in place. Therefore, this message is constrained to a set of IEs which can be sent in the clear. Once the NAS SA is setup, the NAS message encapsulated in this message will be cyphered and the whole Initial WTRU message integrity protected.

Between the initial WTRU message and the initial context setup request, there may be one or more steps where identities, authorization and security at NAS protocol level are performed. These include: the network requests the WTRU identity (SUCI) from the WTRU via the Identity Request NAS message; the WTRU responds to the Identity Request with SUCI in a NAS Identity Response message, where the SUCI is derived from the public key of the Home PLMN; after the network obtains the credentials and master key to derive NAS security keys and other security keys from the AUSF, network initiates NAS authentication; the network sends to the WTRU an Authentication Request, to initiate the authentication procedure with the WTRU, where the key selector, RAND and AUTN is sent to the WTRU; the WTRU responds to the authentication challenge with a NAS Authentication Response message; the network signals the selected NAS security algorithm to the WTRU through a NAS security mode command. The network also requests the IMEISV from the WTRU; and/or, the WTRU signals the completion of the NAS security procedure through a NAS security mode complete, where the message contains the IMEISV.

Additionally/alternatively, the network sends the INITIAL CONTEXT SETUP REQUEST message to the CU. The purpose of the Initial Context setup procedure is to establish the necessary overall initial WTRU Context at the NG-RAN node, when required, including PDU session context, the security Key, Mobility Restriction List, WTRU Radio Capability and WTRU security Capabilities, etc. The network initiates a session setup with the base station. The message typically contains the Registration Accept NAS message. The message carries one or more PDU Session setup requests. Each PDU session is addressed with the “PDU Session ID”.

Additionally/alternatively, the CU sends the WTRU CONTEXT SETUP REQUEST message to establish the WTRU context in the -DU. In this message, it may also encapsulate the securitymodecommand message. In case of NG-RAN sharing, the CU includes the serving PLMN ID (for SNPNs the serving SNPN ID). Next, the DU sends the securitymodecommand message to the WTRU. The securitymodecommand message is used to command the activation of AS security. The WTRU performs one or more of the following actions on receiving the security mode command: derive the K-base station key; K-base station is a key derived by WTRU and network from K-network; derive K-RRC-int key associated with the Integrity Protection Algorithm; verify the integrity protection of the security mode command message; derive K-UP-int key associated with the Integrity Protection Algorithm; and/or, start SRB Integrity Protect.

Additionally/alternatively, the DU sends the WTRU CONTEXT SETUP RESPONSE message to the CU. Next, the WTRU responds with the securitymodecomplete message. The securitymodecomplete message is used to confirm the successful completion of a security mode command. Ciphering will be enabled after sending this message. The security mode complete message is itself not ciphered. The message is however integrity protected. Next, the DU encapsulates the RRC message in the UL RRC MESSAGE TRANSFER message and sends it to the CU. Next, the CU generates the RRCReconfiguration message and encapsulates it in the DL RRC MESSAGE TRANSFER message. Next, the DU sends RRCReconfiguration message to the WTRU. The purpose of this message is to modify an RRC connection, e.g. to establish/modify/release RBs, to perform reconfiguration with sync, to setup/modify/release measurements, to add/modify/release SCells and cell groups. As part of the procedure, NAS dedicated information may be transferred from the network to the WTRU. Next, the WTRU sends RRCReconfigurationcomplete message to the DU. The RRC Reconfiguration complete message is used to confirm the successful completion of an RRC connection reconfiguration. Next, the DU encapsulates the RRC message in the UL RRC MESSAGE TRANSFER message and sends it to the CU. Next, the CU sends the INITIAL CONTEXT SETUP RESPONSE message to the network. This message is sent by the NG-RAN node to confirm the setup of a WTRU context.

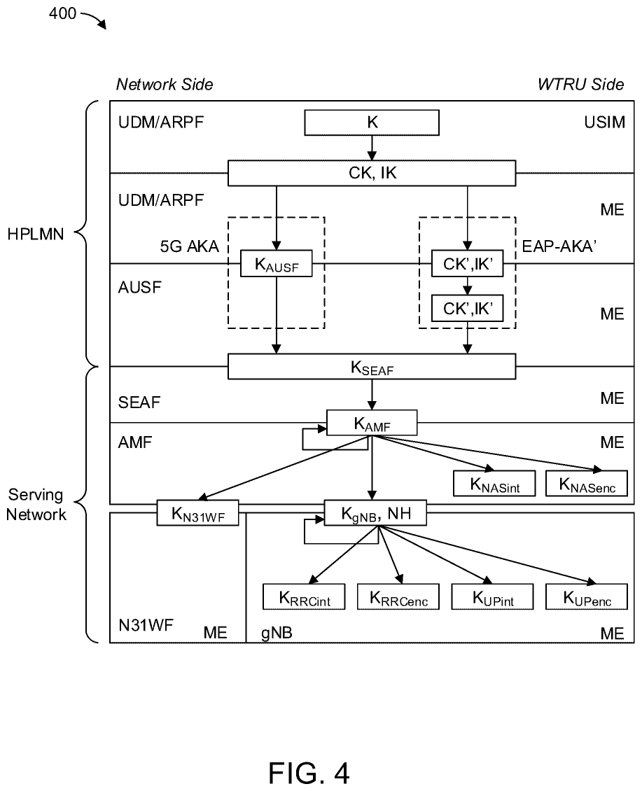

FIG. 4 illustrates an example of a key hierarchy generation for a given wireless system (e.g., 5GS).

In some cases, all the keys used for confidentiality between a WTRU and a base station are derived from a key of the AMF (e.g., KAMF as in the example of FIG. 3), requiring communication between the WTRU and AMF through NAS signaling to set the keys at the base station, before the WTRU can request wireless system services from any other network entity or network function. In these cases, WTRU access to the RAN and NAS signaling procedures to execute system registration, are intertwined (e.g., NAS signaling procedures to register with the Core network are integrated into WTRU procedures to gain access the 5G RAN). FIG. 4 shows the different keys of the 5GS and their relation.

Therefore, it is desirable to enhance the wireless system that uses keys to enable WTRUs to gain access to the wireless transport in the Radio Access network (RAN) and execute security signaling, independently from registration and authentication procedures with any other network elements. This isolation (e.g., independent executing of RAN access from execution of Core network registration and authentication) may enable a WTRU to establish access network connectivity and then interact with any authorized network elements within a network via SBI interfaces.

To isolate access network connection establishment for SBI WTRU access from network registration and authentication, the one or problems need to be addressed, such as: how a WTRU discovers a network, specifically RAN nodes within a network, that supports SBI WTRU access and what the SBI WTRU capabilities are available from those nodes; how a WTRU establishes an access connection with a RAN Node that supports SBI WTRU access to elements in the network that is independent from registration and authentication with any element in that network; how this access connection provides sufficient connectivity capabilities to meet the WTRU's and the network's requirements for connectivity and security (e.g., IP address assignment or other identification of the WTRU, confidentiality, integrity, etc.); and/or, after an access connection is established with a RAN node for SBI WTRU access with sufficient capabilities, how the WTRU authenticates, establish higher-layer security, and interaction via SBI interfaces with entities in the network.

In order to enable SBI WTRU communication, a given system may need to decouple WTRU access establishment and connectivity to the RAN, such as attachment and initial WTRU access to a RAN node (e.g., including the acquisition of an IP address for SBI communication) from the authentication and security negotiation with the Core network or network elements within it.

In some cases, these functions can be tightly coupled in WTRU RAN connection establishment with a base statin including NAS registration with the Core network (e.g., the WTRU Initial Access Procedure with a base station in the 5GS includes interaction with the AMF). All communication from the WTRU to elements in the 5GC (such as NFs) may then be exchanged, or tunneled, through NAS signaling with the AMF. This may cause a system bottleneck and potentially a key point of failure that may not scale as systems evolve and change, affecting reliability and possibly increasing latency.

As described herein, there are one or more methods, devices, and/or systems for a WTRU to establish an access connection to a RAN node that is independent, or decoupled, from the Core network, including its authentication and security. The WTRU may communicate with network elements in a Core network using SBI interfaces over a RAN access connection. This SBI approach may be in whole or in part, where use of the AMF may continue in certain situations.

For SBI WTRU communication, there needs to be an initial communication establishment that enables further connectivity. The WTRU may establish a connection to a RAN node and acquire connectivity to communicate with one or more network elements in the Core network, without requiring registration or authentication with the Core network or elements within it (e.g., an AMF in a 5GS).

Generally, RAN connectivity for SBI WTRU communication may or may not include authentication, cyphering, or integrity protection, based on network configuration and WTRU capabilities. After access connection is established with a RAN node, the WTRU may interact with desired network elements via their service-based interfaces (SBIs). Based on security level configuration, the RAN node may limit the number of messages exchanged, for example to only allow specific types of messages or packets (e.g., messages using SBI protocols, messages for initiating connectivity, emergencies, etc.), or any other mechanisms to protect the RAN node and its access links.

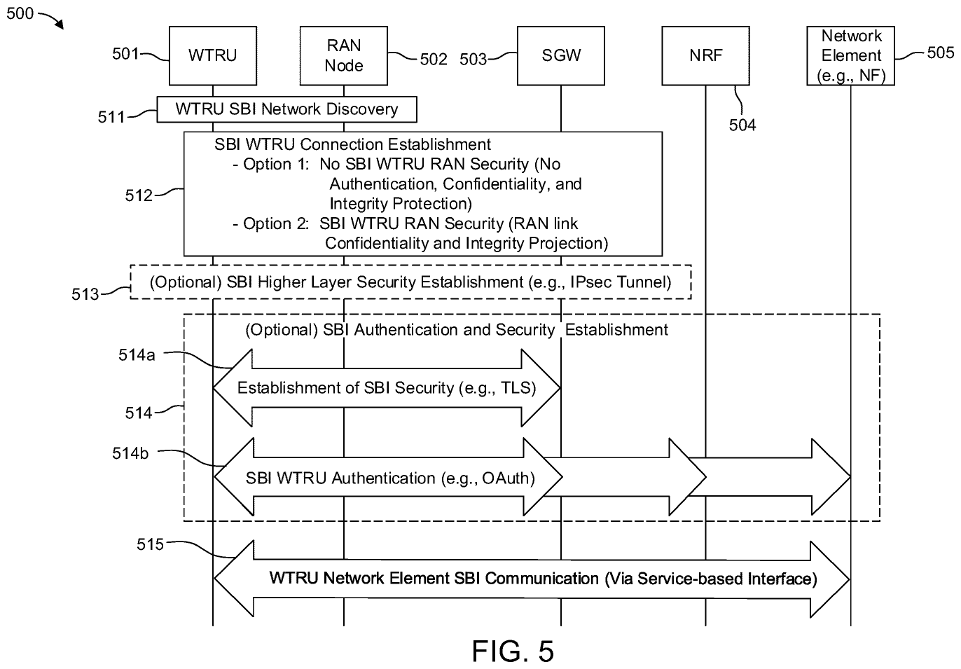

FIG. 5 illustrates an example of SBI WTRU communication establishment. In the example procedure, a WTRU may discover a network supporting direct SBI WTRU access, create a connection to a RAN node in the network, configure any required SBI security mechanisms, and establish SBI communication between the WTRU and network elements in the Core network. In the example illustrated, there may be a WTRU 501, a RAN node 502, a SGW 503, an NRF 504, and/or a network element (e.g., NF) 505.

Prior to the initial step (e.g., WTRU SBI network discovery), it may be assumed for this example that the WTRU is pre-configured with sufficient information and credentials to establish a connection to a RAN node in the network. Additionally, the WTRU may be pre-configured with information regarding which network elements it needs to interact with and/or knows their service-based interface protocols and data models. The WTRU may be pre-configured with communication endpoint information for the network elements. Alternatively, the WTRU may discover the network elements through a service such as the network Repository Function (NRF), a discovery service or enabler, DNS, or other mechanism. In an instance described herein regarding pre-configuration, the WTRU may receive configuration information or may be pre-configured with configuration information that the WTRU to perform SBI discovery.

Additionally/alternatively, at 511, the WTRU discovers that a network, via a RAN node, supports SBI WTRU connections. The WTRU may be connected to a network or unconnected. The RAN node may advertise to a WTRU its supported SBI WTRU capabilities, including: SBI WTRU Connection Availability, which indicates if SBI WTRU connection is available or not via the RAN node; SBI WTRU RAN security, which indicates SBI WTRU security between WTRU and RAN node is required or not; and/or, SBI WTRU High-Layer (HL) security, which indicates SBI WTRU security between the WTRU and a SBI Gateway (SGW) is required or not.

Based on the received SBI WTRU capabilities from the RAN node, the WTRU may decide to establish an access connection to the RAN node for SBI WTRU communication and identifies how to establish any required security mechanisms for that RAN node. If the WTRU finds the RAN node capabilities satisfies its requirements, the WTRU may proceed to 512; otherwise, the procedure may end (e.g., SBI communication is not possible at this time).

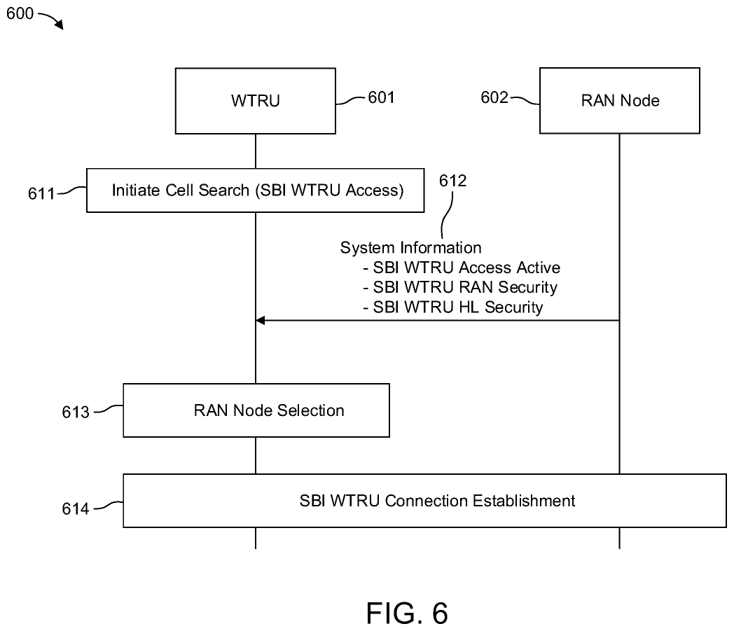

Approaches and techniques regarding how a WTRU discovers SBI WTRU capabilities from a RAN node is described further herein (e.g., FIG. 6 and related description).

Additionally/alternatively, at 512, using the SBI WTRU capability information received previously, the WTRU may establish an access connection to the RAN node for SBI WTRU communication. The WTRU may request connection establishment indicating SBI WTRU access (e.g., via an enhanced RRC WTRU Initial Access procedure, etc.). In some instances, the WTRU may also indicate what type of SBI WTRU security options the WTRU desires or supports (e.g., no security, SBI WTRU RAN security, SBI WTRU Higher-layer security, or both). The RAN node may verify the WTRU for SBI WTRU access (e.g., by contacting an appropriate CN NF, such as a UDM), and the RAN node may configure the access network for SBI WTRU communication in the RAN. The RAN node may inform the WTRU of this configuration.

Based the SBI WTRU RAN security configuration, there may be more than one security options for SBI WTRU RAN access.

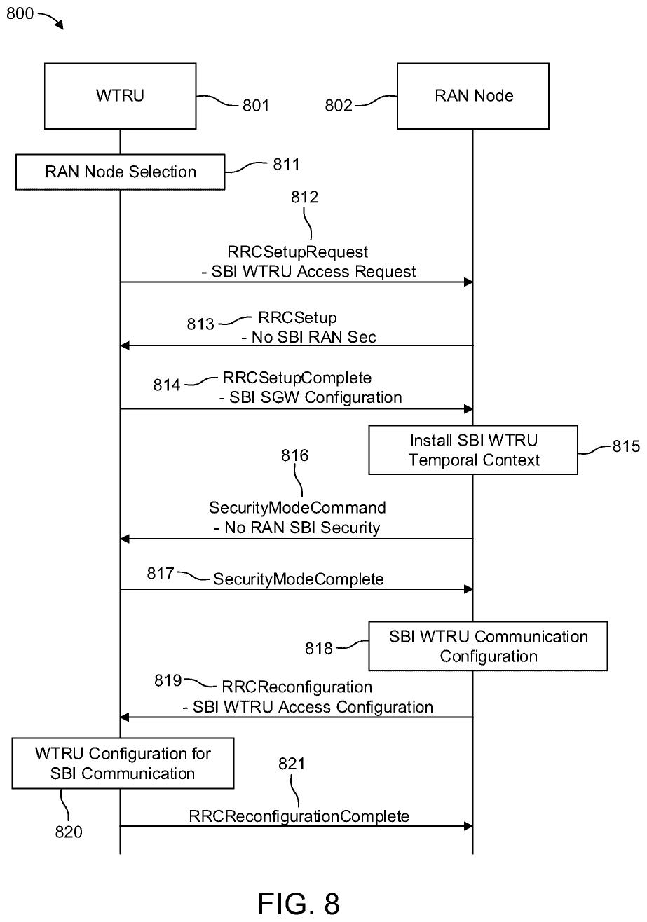

Option 1 is where RAN connection security is not required or supported (including no authentication, cyphering or integrity protection). This option may be appropriate for NPN, CPN, or private network deployments to simplify network/device management and reduce operational costs. This option is described further herein (e.g., FIG. 8 and related description).

Option 2 is where RAN connection security is required including cyphering and integrity protection. This option is appropriate for public or MNO deployments. This option is described further herein (e.g., FIG. 8, 15, 19, and related description).

Additional options may exist, such as partial security requirements combining aspects of options 1 and 2.

Additionally/alternatively, at 513, if the RAN node and the WTRU agree in at 512 for SBI Higher Layer security, the WTRU may establish a secure SBI Higher-Layer security tunnel with the SGW (e.g., IPsec). The WTRU and SBI network elements may exchange SBI messages and/or other message/traffic via or within this secure tunnel.

Additionally/alternatively, at 514, there may be SBI authentication and security establishment. At 514a, the WTRU may establish an additional secure connection with either the SGW or with the target network elements directly (or through the SGW), for example via TLS or with other SBI security methods. The WTRU may discover the communication endpoint of network elements in the Core network via an NRF or other discovery service. At 514b, the WTRU may request authorization with any required network elements (SGW, NRF, or other NFs/AFs, etc.) using mechanisms such as OAuth. In some deployments, neither of these mechanisms (a or b) may be used, such as in a private network.

Additionally/alternatively, at 515, the WTRU may communicate with network elements in a Core network using their SBI interfaces and protocols. These network elements may be equivalent to or the same as 5GC NFs. These network elements may also include network elements/functions for 6GS or beyond.

FIG. 6 illustrates an example of SBI WTRU access RAN node selection. As shown, there is a WTRU 601 and a RAN Node 602. In this example, there may be a method for a WTRU to discover a network that supports SBI WTRU access and select a RAN node within the network for SBI WTRU connection. While performing Cell Search and selecting a RAN node for access network connection, the WTRU may receive system information (e.g., a set of System Information Blocks (SIBs) and/or a Master Information Block (MIB)) relevant to evaluate if the WTRU is able to access a network and what capabilities that the network and a RAN node may support. For this example, SBI WTRU access capability information may be included within system information (e.g., SIB1, etc.) in order to enable: a RAN node to advertise network supported SBI WTRU access capabilities to WTRUs before or after WTRU connection establishment; and/or, a WTRU to determine the SBI WTRU access capability of a RAN node and make an appropriate RAN node selection to establish SBI WTRU access.

Initially for this method, it may be assumed that the WTRU is pre-configured with sufficient information to connect to the RAN node in the network. Additionally and internal to the WTRU, the need to interact with one or more network elements in the core network via SBI access has been triggered.

Additionally/alternatively, at 611, the WTRU may initiate a cell search and system information acquisition procedure to select a RAN node that supports SBI WTRU access to elements in a core network. The WTRU may start to acquire system information blocks that are transmitted from one or more RAN nodes (e.g., RAN Node 602).

Additionally/alternatively, at 612, the RAN node transmits system information to the WTRU, including its SBI WTRU access capability information: SBI WTRU Connection Availability, which indicates if SBI WTRU access is available via the RAN node (or not); SBI WTRU RAN security, which indicates SBI WTRU RAN security between WTRU and RAN node is required (or not); and/or, SBI WTRU HL security, which indicates SBI WTRU HL security between the WTRU and a SGW other elements in the network is required (or not).

The WTRU may receive system information blocks from one or more RAN nodes. A RAN node may use one or more network Slice(s) to signal any of the capabilities described herein.

Additionally/alternatively, at 613, based on the SBI WTRU access capability information received previously, the WTRU may select an appropriate RAN node for SBI WTRU connection establishment. The WTRU may consider other cell selection and system information criteria in RAN node selection (e.g., the supported network Slice(s)).

For selecting a RAN node for SBI WTRU access, the WTRU may use the received SBI WTRU access capability system information as follows: 1) selecting a RAN node that supports SBI WTRU access; 2) selecting a RAN node that supports SBI WTRU RAN security, if needed by the WTRU; and/or, 3) selecting a network that supports SBI WTRU HL security, if needed by the WTRU.

Additionally/alternatively, at 614, after RAN node selection, the WTRU may establish a SBI WTRU connection to the selected RAN node. The WTRU may use the SBI WTRU RAN security indication from previously to decide if RAN security is needed and based on this indication selects between: Option 1-No security (e.g., if no RAN security is required, the WTRU may establish the SBI WTRU connection with the RAN node as described herein); or Option 2-RAN security (e.g., if RAN security is required, the WTRU may establish the SBI WTRU connection with the RAN node as described herein).

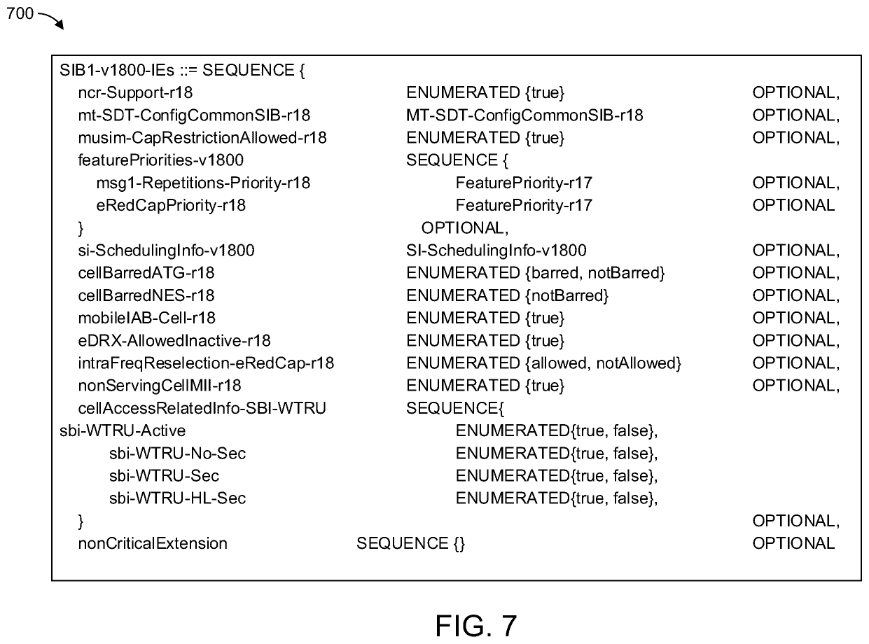

FIG. 7 illustrates an example of system information block 1. The IE shown is merely for illustration purposes, and an IE used in the one or more procedures disclosed herein may not include one or more fields as shown (e.g., order to reduce the size of the IE) and/or may include one or more fields not shown (e.g., some other field disclosed herein). Aspects of the IE may be based on legacy approaches, or the IE may not be based on legacy approaches, and represent a new IE relative to legacy approaches.

In one example, in order for a RAN node to advertise SBI WTRU access to a WTRU (e.g., 612) and for a WTRU to determine that a network and a RAN node within it supports native WTRU SBI communication (e.g., 613), existing system information instances may be enhanced/modified, etc., to enable this advertisement. For instance, System Information Block 1 (SIB1), may provide SBI WTRU Access Capability Information to the WTRU regarding the use of SBI at the terminal to access one or more network elements in the core network. Although SIB1-v1800-IEs within the SIB1 is used in the example of FIG. 7, the SBI WTRU Access Capability Information may be provided in any System Information that may be used for 4G, 5G, etc. or in a new system information block. The SIB1 of FIG. 7 includes SBI WTRU Access Capability Information, such as in the lines that reference SBI.

In the example of FIG. 7, the SBI WTRU Access Capability Information (cellAccessRelatedInfo-SBI-WTRU) in SIB1 corresponds to the advertisement by the RAN node of the support of direct SBI WTRU access to network elements in the core network via an SBI interface. The cellAccessRelatedInfo-SBI-WTRU represents the structure carrying the information regarding the support SBI WTRU Access Capability to the network, such as: sbi-WTRU-Active; sbi-WTRU-No-Sec; sbi-WTRU-Sec; and/or, the sbi-WTRU-HL-Sec.

In the example of FIG. 7, the sbi-WTRU-Active variable indicates the availability of direct SBI WTRU access functionality in the RAN node. TRUE indicates that direct SBI WTRU access is active and available. FALSE or missing indicates that that direct SBI WTRU access is not available.

In the example of FIG. 7, the sbi-WTRU-No-Sec indicates if direct SBI WTRU access without any RAN node security or privacy is available. TRUE indicates that the WTRU may establish direct SBI access without any security, such as described in herein. Otherwise, direct SBI WTRU access without RAN node security is not available.

In the example of FIG. 7, the sbi-WTRU-Sec indicates if direct SBI WTRU access with RAN node security or privacy is available. TRUE indicates that the WTRU may establish direct SBI access with security, such as described herein. Otherwise, direct SBI WTRU access with RAN node security is not available.

In the example of FIG. 7, the sbi-WTRU-HL-Sec indicates support of an SBI gateway that requires higher-layer security towards which the WTRU may establish a protected tunnel (e.g., IPSec) and exchange the SBI messages in a secure way considering higher layer cyphering, such as described herein.

The choice of using an enumeration for indicating SBI WTRU Access Capability Information may be an implementation option. Another implementation may use another mechanism or data format to convey this information, for example a bitmap. Additionally, although this approach utilizes System Information as the mechanism to send SBI WTRU access capability information from the network (RAN node) to the WTRU, any mechanism for a network or RAN node to send capability information to a WTRU in either a connected or unconnected state may be used (e.g., control information, RRC message, DCI message, etc.); said another way, the information on the support of SBI or lack of it and what the security mechanisms should be may be exchanged between the WTRU and RAN by one or message of any type.

FIG. 8 illustrates an example of SBI WTRU connection establishment with no security. As shown, there may be a WTRU 801 and RAN Node 802. As discussed herein, in order to enable SBI WTRU communication it may be necessary to decouple WTRU access to the RAN, such as attachment to a RAN node and acquisition of an IP address, from the authentication and security negotiation with the core network or network elements within it (e.g., as is required with the AMF in the 5GS). To achieve this, FIG. 8 provides an example of an enhanced WTRU Initial Access procedure to request SBI WTRU connectivity that is decoupled from any network element registration, authentication, etc. in the Core network (e.g., compared to the existing 5GS procedure). The RAN node may be assumed to have no or limited configuration information about a Core network, for example no information of IP configuration of the network elements (e.g., NFs, AFs, SGWs, or other services) in the network.

This approach, illustrated in the example of FIG. 8, describes a WTRU Connection Establishment procedure to establish SBI WTRU access to the network when the WTRU and the RAN node do not negotiate any SBI WTRU RAN security. In contrast, there are other approaches described herein that described an enhanced WTRU Initial Access procedures when SBI WTRU RAN security is applicable.

In this approach, there may be communication between the WTRU and an atomic RAN node (e.g., a stand-alone gNB). However, this example also implies split RAN deployments (e.g., with a gNB-DU and gNB-CU). The signaling between the DU and CU may be impacted by the modification to the RRC messages for this example.

Initially, it may be assumed that the WTRU is configured with sufficient information to establish a connection to the RAN node in the network. The WTRU may also be configured with sufficient information on network elements, SGW, or other services in the network that it needs to interact via their SBI interfaces. Internal to the WTRU, the need for the WTRU to interact with one or more of network elements via SBI access has been triggered that requires connection establishment.

Additionally/alternatively, at 811, the WTRU may select a RAN node for SBI WTRU connection establishment, for example, according to one or more techniques described herein.

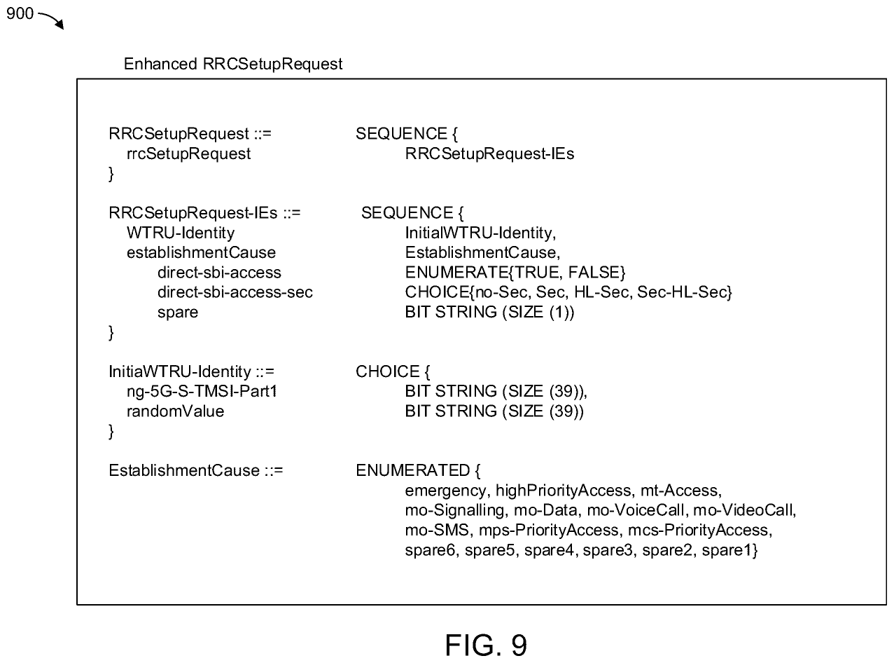

Additionally/alternatively, at 812, the WTRU may send an enhanced RRCSetupRequest message to the RAN node requesting SBI WTRU access. This RRCSetupRequest message may include information to request WTRU SBI (e.g., FIG. 9).

FIG. 9 illustrates an example of an enhanced RRCSetupRequest message. Note, as shown there are one or more lines that are relevant to SBI communication, as further described herein. The message shown is merely for illustration purposes, and a message used in the one or more procedures disclosed herein may not include one or more fields as shown (e.g., in order to reduce the size of the message) and/or may include one or more fields not shown (e.g., some other information disclosed herein). Aspects of the message may be based on legacy approaches, or the message may not be based on legacy approaches, and represent a new message relative to legacy approaches.

For example, the direct-sbi-access field may indicate the request from the WTRU is to initiate direct WTRU SBI access to the network. The direct-sbi-access-sec field indicates the choice of security association required: 1) no-Sec indicates no SBI WTRU RAN security, authorization, or confidentiality, 2) Sec indicates a SBI WTRU RAN security association; 3) HL-Sec indicates that higher layer SBI WTRU security; 4) Sec-HL-Sec indicates both SBI WTRU RAN security association and higher layer SBI WTRU security association.

In a different approach, both direct-sbi-access and direct-sbi-access-sec may be included in a separated IE or in different IEs from the ones described herein.

In the approach where security is not required, the WTRU may set direct-sbi-access=TRUE and direct-sbi-access-sec=no-Sec in the enhanced RRCSetupRequest message. If SBI HL security is needed (e.g., without SBI RAN security), the WTRU may set direct-sbi-access-sec=no-Sec. The procedure for SBI HL security is described further herein.

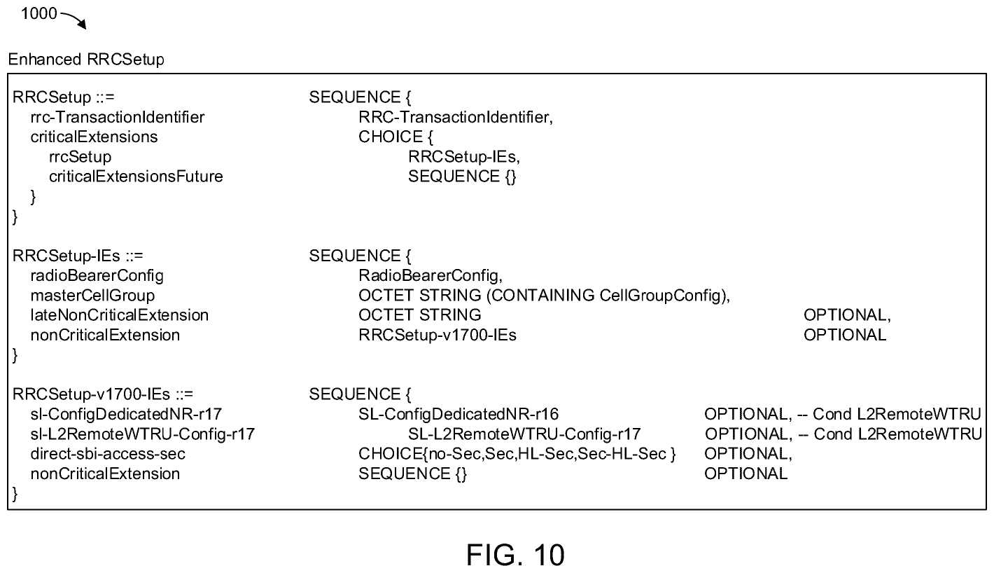

Additionally/alternatively, at 813, upon reception of the enhanced RRCSetupRequest from the WTRU, the RAN node may process the WTRU's request for direct SBI WTRU access to the network, in this case without any security. The RAN node may allocate a C-RNTI for the WTRU, create an RRC configuration, and configure radio bearers for the initial setup link without any security protection. The RAN node may send an enhanced RRCSetup message to the WTRU. The RRCSetup message may be enhanced to indicate SBI WTRU access without security (e.g., FIG. 10).

FIG. 10 illustrates an example of enhanced RRCSetup message. Note, as shown there are one or more lines that are relevant to SBI communication, as further described herein. The message shown is merely for illustration purposes, and a message used in the one or more procedures disclosed herein may not include one or more fields as shown (e.g., in order to reduce the size of the message) and/or may include one or more fields not shown (e.g., some other information disclosed herein). Aspects of the message may be based on legacy approaches, or the message may not be based on legacy approaches, and represent a new message relative to legacy approaches.

In the case where security is not required, the RAN Node sets direct-sbi-access-sec=no-Sec in the enhanced RRCSetup message. Alternatively, the RAN node may simply omit the direct-sbi-access-sec indication in the enhanced RRCSetup message, which also signals to the WTRU that SBI WTRU security is not required.

In this example procedure, direct-sbi-access-sec has been added to the RRCSetup-v1700-IEs. However, the direct-sbi-access-sec parameter may be added to any other IE in the RRCSetup message or as a separate IE.

Additionally/alternatively, at 814, the RRC connection establishment procedure proceed with receiving the enhanced RRCSetup message from the RAN node, where the WTRU may verify that SBI WTRU access without security is acceptable based on its configuration. The WTRU may respond with an enhanced RRCSetupComplete message to the RAN node.

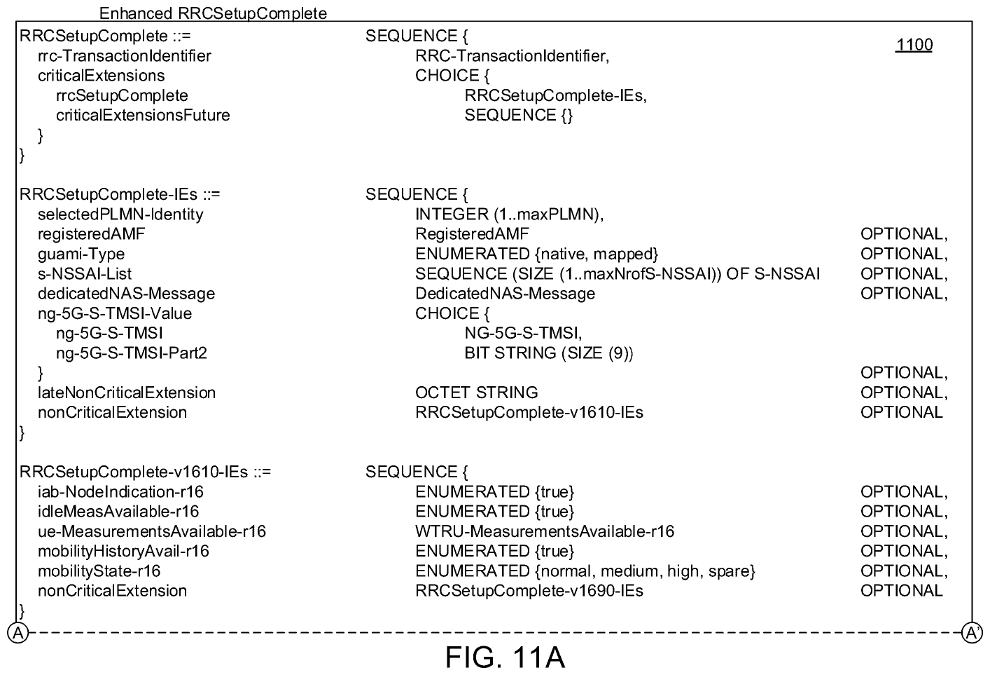

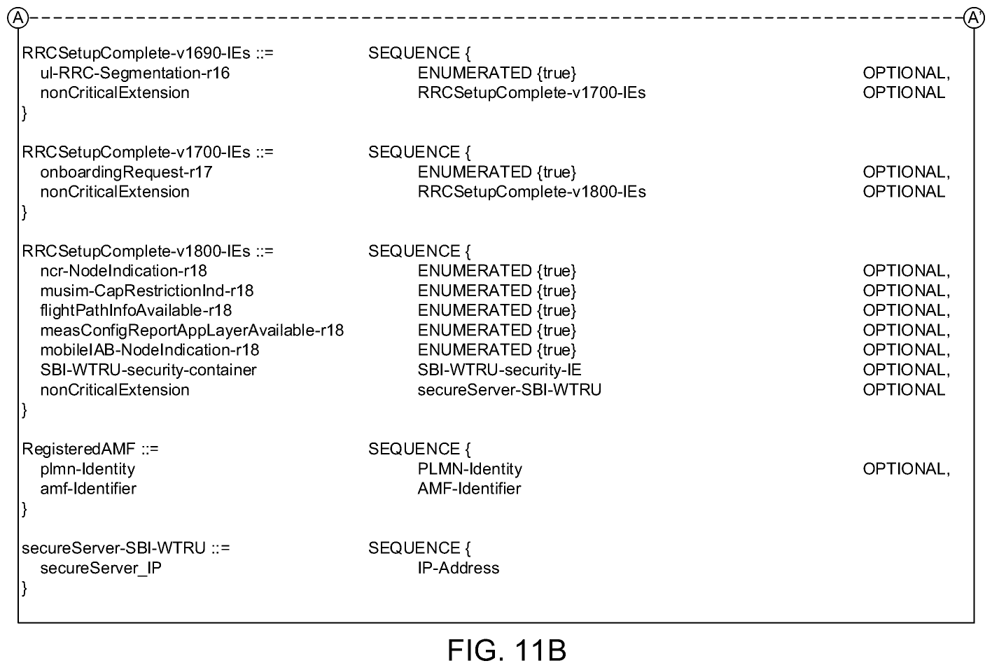

FIGS. 11A and 11B (collectively referred to as FIG. 11) illustrates an example of an enhanced RRCSetupComplete message. Note, as shown there are one or more lines that are relevant to SBI communication, as further described herein. The enhanced RRCSetupComplete message sent by the WTRU may include one or more aspects specific to SBI. The message shown is merely for illustration purposes, and a message used in the one or more procedures disclosed herein may not include one or more fields as shown (e.g., in order to reduce the size of the message) and/or may include one or more fields not shown (e.g., some other information disclosed herein). Aspects of the message may be based on legacy approaches, or the message may not be based on legacy approaches, and represent a new message relative to legacy approaches.

For example, as shown in FIG. 11, since there is no interaction from the RAN node to the any elements in the Core network (such as the 5GC AMF) in this procedure, the enhanced RRCSetupComplete message may not include a dedicatedNAS-message, which carries the NAS Registration message in a non-SBI WTRU Initial Access procedure. In the enhanced RRCSetupComplete message definition, the dedicatedNAS-message field may be changed from mandatory to optional.

For example, as shown in FIG. 11, the registered AMF identifier may not be included in the enhanced RRCSetupComplete message.

For example, as shown in FIG. 11, a new extension, secureServer-SBI-WTRU, may be set by the WTRU to inform the RAN node of any SBI WTRU access SGW information that may be configured in the WTRU regarding the Core network. This field may indicate the IP address of the SGW in the network in order to instruct the RAN node where to forward the SBI messages from the WTRU (e.g., as described herein). As alternatives to an IP address, the SGW may be indicated in secureServer-SBI-WTRU by a L2 address, a FQDN, or any other identifier. The SBI WTRU access SGW may be configured independently of any higher layer SBI WTRU security configuration or SBI WTRU RAN security configuration.

For example, as shown in FIG. 11, the PreRegistration-security-IE (SBI-WTRU-security-container) may be an optional information element in the enhanced RRCSetupComplete message. However, it may not be included in the message for this procedure where SBI WTRU RAN security is not utilized. This field may be further defined herein as it relates to other scenarios (e.g., with security).

In one instance, secureServer-SBI-WTRU and PreRegistration-security-IE may be added to the RRCSetupComplete-v1800-IEs. However, these parameters may be added to any other IE in the enhanced RRCSetupComplete message or as a separate IE.

Additionally/alternatively, at 815, RAN node may receive the enhanced RRCSetupComplete message and install a new temporal reduced WTRU context in the RAN Node to manage the WTRU's SBI communication. Since the RAN node is operating without any core network interaction (e.g., an AMF), it creates the temporal reduced WTRU context, which may be used by the RAN node for SBI message exchange between the WTRU and the network elements, SGW, or services in the selected core network. This temporal reduced WTRU context may be replaced by a RAN node if there is a successful registration (e.g., NAS registration) of the WTRU with a selected core network or network element (e.g., an AMF in a 5GS).

The temporal reduced WTRU context may include one or more pieces of information as described herein, for example. This table is not intended to limit what may be included in the temporal reduced WTRU context.

TABLE 1
SBI WTRU Temporal Reduced Context

| Information | Description |
|---|---|
| RAN WTRU | Similar to the RAN WTRU NGAP ID, this |
| TEMP ID | identifier temporally identifies the WTRU |
| | while not registered in the network |
| SBI WTRU | IP Address (IPv4 or IPv6) as provided by |
| SGW IP | the WTRU in the enhanced |
| | RRCSetupComplete message |
| WTRU SBI | IP Address (IPv4 or IPv6) assigned or |
| IP Address | provided by the RAN node to the WTRU for |
| | direct SBI WTRU access to the Core network. |
| | An alternative identifier or address for the |
| | SBI WTRU may be used instead of an IP address. |
| PLMN ID | Identifier of the PLMN, as provided by the |
| | WTRU in the PLMN-identity IE in the |
| | enhanced RRCSetupComplete message, |
| | or another core network identifier |
| WTRU security | Indication of the desired level of security |
| Capability | requested by the WTRU in the enhanced |
| | RRCSetupRequest message - |
| | CHOICE{no-Sec, Sec, HL-Sec, Sec-HL-Sec} |
| Key Material | Key material for security purposes |

Not all the fields in the temporal reduced WTRU context may be filled after the reception of the RRCSetupComplete message. For example, the key material when security is used or the WTRU SBI IP address. At this point, the RAN node may have not started the security association exchange with the WTRU. This field may be populated at a later time. The structures and choices of the context information elements may be implementation specific and may be realized in different formats. For example, the WTRU security Capability may be implemented as bitmap, enabling simultaneous mechanisms, instead of as a choice.

Additionally/alternatively, at 816, the RAN node may initiate security association with the WTRU, which in this example scenario is no SBI WTRU RAN security. The RAN node may send a securitymodecommand message to the WTRU. This message may include the algorithm(s) to be used to derive the different keys to secure the NAS communication in the (e.g., 5GS) (which do not apply for SBI WTRU access) and the cyphering at the PDCP layer of the RAN. In this case of no SBI WTRU RAN security, the RAN node in the securitymodecommand message may indicate a null ciphering and integrity protection algorithm, such as the NEA0 algorithm.

Additionally/alternatively, at 817, the WTRU may set its security association to no SBI WTRU RAN security (e.g., null ciphering and integrity protection) from the information received in the securitymodecommand from 816. The WTRU may respond with a securitymodecomplete message to the RAN node as an acknowledgement. At this point, the configuration of the SBI WTRU RAN security (e.g., 5G RRC security, 6G RAN security, WiFi security, etc.) may be completed.

Additionally/alternatively, at 818, the RAN Node may configure the communication connection in the network for the WTRU to access network elements via SBI in the core network. In this case, the WTRU may only use this connection to exchange SBI messages with network elements in the Core network. The RAN node may configure the control (SRB) or data (DRB) bearers to carry the SBI messages from the WTRU. Therefore, the WTRU may use a control channel to do so and may not need to setup a PDU session for SBI messages. The RAN node may assign an address (e.g., IP address, or other identifier), to the WTRU to enable the transfer of SBI messages with network elements in the core network. The address may be IPv4, IPv6, public or private, depending on deployment and implementation specific needs. The RAN node may store the SBI WTRU IP configuration information in the temporal reduced WTRU context for the WTRU. In one instance, the IP configuration information may include an IPV4 and/or IPv6 address, mask or prefix, and gateway (Dgw), or any applicable identifiers or addresses for SBI communication in the network.

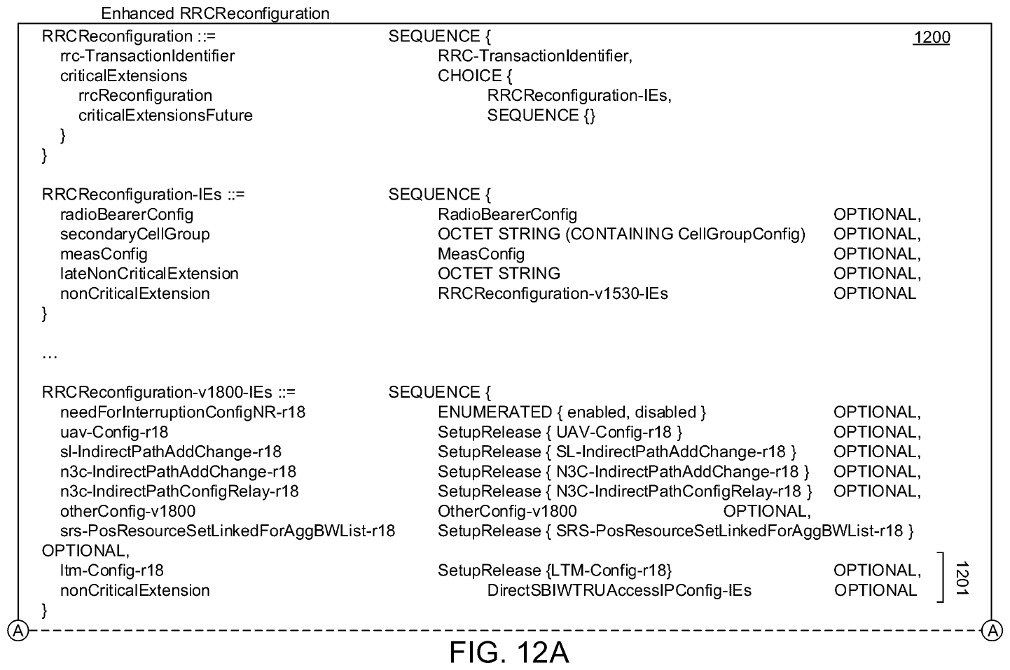

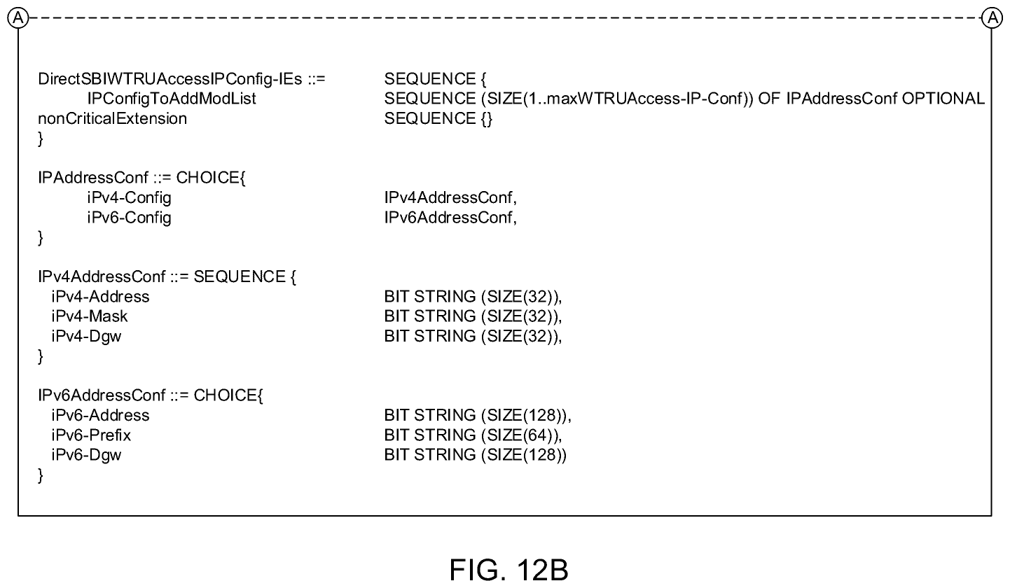

FIGS. 12A and 12B (collectively referenced as FIG. 12), may illustrate an example of an Enhanced RRCReconfiguration message. Note, as shown there are one or more lines that are relevant to SBI communication, as further described herein. The message shown is merely for illustration purposes, and a message used in the one or more procedures disclosed herein may not include one or more fields as shown (e.g., in order to reduce the size of the message) and/or may include one or more fields not shown (e.g., some other information disclosed herein). Aspects of the message may be based on legacy approaches, or the message may not be based on legacy approaches, and represent a new message relative to legacy approaches.

Additionally/alternatively, at 819, the RAN node may send an enhanced RRCReconfiguration to the WTRU to inform it of the SBI WTRU communication configuration created in 818, including the SBI WTRU IP address assigned by the RAN node and the RAN access configuration (e.g., configuration for SRBs and/or DRBs).

Modifications to the enhanced RRCReconfiguration message may be shown in FIG. 12. Note, not all fields defined herein are shown in the illustrated example of FIG. 12. Any missing fields may be assumed to be included in the message. An extension for the SBI WTRU IP configuration, directSBIWTRUAccessIPConfig-IEs, may be added to the RRCReconfiguration-v1800-IEs. This configuration may include SBI WTRU IPv4 and/or IPv6 address, mask or prefix and gateway (Dgw), assigned by the RAN node at 818.

In the enhanced RRCReconfiguration, the RAN node may inform the WTRU of the control (SRB) or data (DRB) bearers to carry the SBI messages from the WTRU. This may be done by including the configuration in the radioBearerConfig parameter. Within this parameter (e.g., both cases, SRB or DRB configuration), the RAN node may include a pdcp-Config element. For this case with no security, where no ciphering or integrity is used, the parameters cipheringDisable and integrityProtection may be set to disable this characteristic.

In some cases, the configuration of parameters required for the SBI communication (e.g., as discussed herein), may be independent from the actual nature of the radio bearers. They may be independent from a radio bearer (RB) being for control signaling or data. Additionally, a generic radio bearer with the same parameters may work to configure and establish the SBI communication.

The actual implementation of the parameters for SBI WTRU access configuration in the IEs of the enhanced RRCReconfiguration message may differ from what is described herein and/or shown. The information may be realized in different IEs depending on the implementation.

The pdcp-Config information element within the RadioBearerConfig may indicate (e.g., by modifying existing formats) that the configured radio bearer should only be used for WTRU SBI messages.

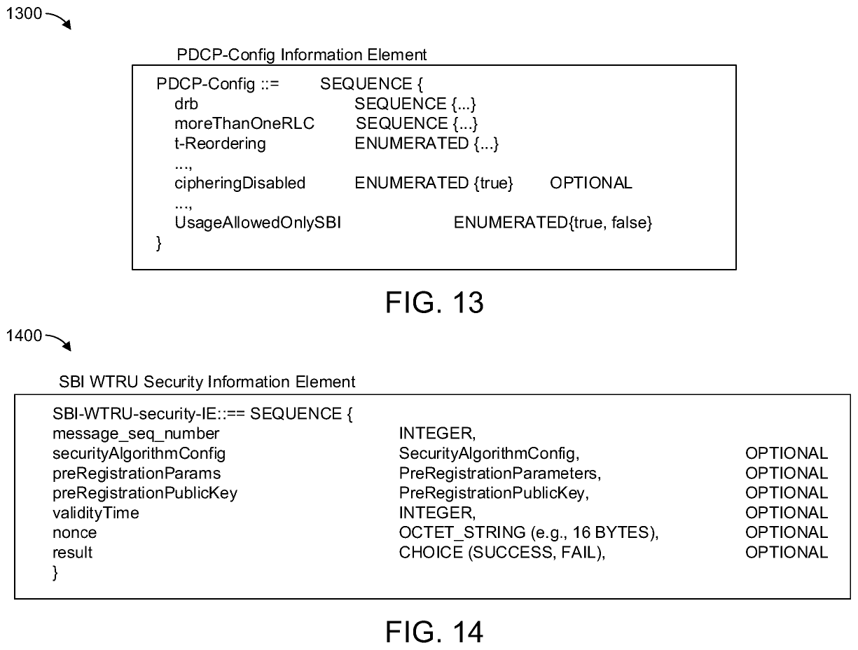

FIG. 13 illustrates an example of a PDCP-config information element. Note, as illustrated the element may not show a complete pdcp-Config IE for simplicity. Note, the IE includes a UsageAllowedOnlySBI which may be enumerated as (true, false). The IE shown is merely for illustration purposes, and an IE used in the one or more procedures disclosed herein may not include one or more fields as shown (e.g., order to reduce the size of the IE) and/or may include one or more fields not shown (e.g., some other field disclosed herein). Aspects of the IE may be based on legacy approaches, or the IE may not be based on legacy approaches, and represent a new IE relative to legacy approaches.

Additionally/alternatively, at 820, the WTRU may use the SBI WTRU access configuration information from the received enhanced RRCReconfiguration to configure its internal communication resources (e.g., SRB and/or DRB settings, etc.) and set its SBI WTRU IP configuration.

Additionally/alternatively, at 821, the WTRU may respond to the RAN node with an RRCReconfigurationcomplete message to acknowledge that the SBI WTRU connection configuration is complete.

Following 821 or 820, the WTRU and RAN node may be sufficiently configured, with no security, to exchange SBI WTRU messages between the WTRU and elements in the network. There may be other approaches, as described herein, that use similar or the same actions as in the example FIG. 8, but with security, as further described herein.

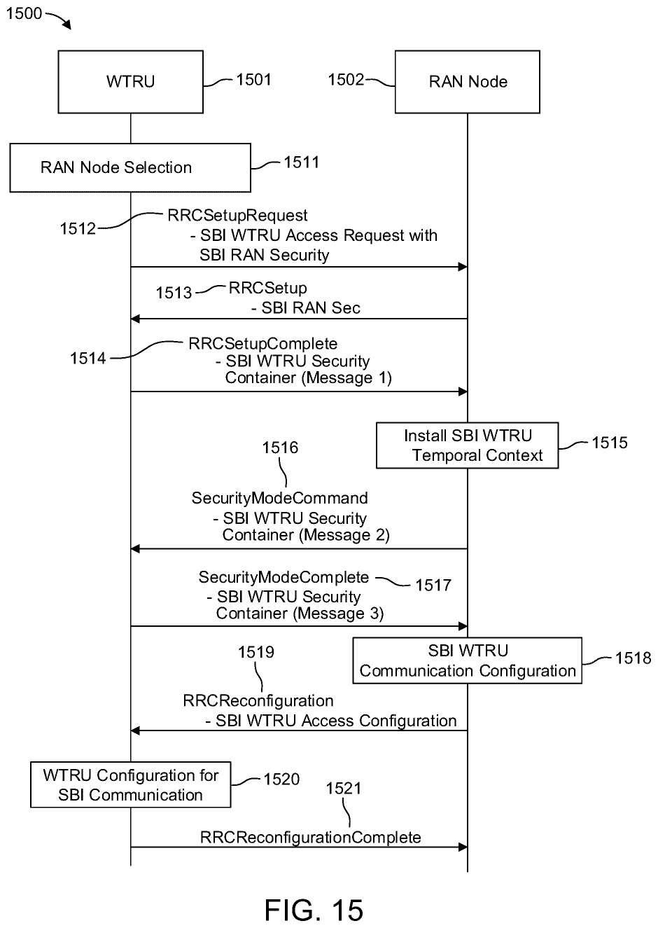

FIG. 15 illustrates an example of a SBI WTRU connection establishment with SBI WTRU RAN security. As shown, there may be a WTRU 1501 and a RAN Node 1502.

In the example approach as illustrated in FIG. 15, there is an enhanced WTRU Connection Establishment procedure to establish SBI WTRU access to the network, where SBI WTRU RAN security (e.g., for confidentiality or authentication) is negotiated and established between the WTRU and a RAN node. It is similar to the example of FIG. 8 where there is no SBI RAN security (e.g., but with security); as such, it maintains similar goals of decoupling WTRU access to the network, such as attachment to a RAN node and acquisition of an IP address for SBI communication, from the authentication and security negotiation with the Core network or network elements within it (e.g., the AMF in the 5GS). This approach defines a novel security key exchange procedure between the RAN node and WTRU. This new exchange, may occur without intervention from the Core network (e.g., pre-registration with any Core network elements); further, it may enable the RAN node and WTRU to generate a pairwise security key, based on any mechanism to generate a shared secret between two peers without previous knowledge, such as Diffie-Hellman exchange, or any other mechanism based on a generated shared secret between the WTRU and the RAN Node.

FIG. 14 illustrates an example of SBI WTRU security Information element (e.g., element 2). In order to exchange with SBI WTRU RAN security information (e.g., for the example procedure of FIG. 15), a SBI-WTRU-security-IE information element may be needed. The IE shown is merely for illustration purposes, and an IE used in the one or more procedures disclosed herein may not include one or more fields as shown (e.g., order to reduce the size of the IE) and/or may include one or more fields not shown (e.g., some other field disclosed herein). Aspects of the IE may be based on legacy approaches, or the IE may not be based on legacy approaches, and represent a new IE relative to legacy approaches. The parameters in this IE may include one or more of the following: security algorithm configuration information (securityAlgorithmConfig); pre-registration parameters (preRegistrationParams); a pre-registration public key (preRegistrationPublicKey); a time period for the exchange (validityTime); a nonce value; a message sequence number (message_seq_num); and/or a result indication.

For the example, the securityAlgorithmConfig may include information on the ciphering algorithm to be used, considering that new ciphering mechanisms may be needed for this purpose in the future. It may also include an indication on the algorithm that may be used to compute message Integrity Codes.

For example, preRegistrationParams may include parameters needed to generate compatible public and private keys at the peer nodes, WTRU and RAN node. For example, if Finite Cyclic Groups are used, a common group may be used between the peers.

For example, preRegistrationPublicKey may be a Public key to be used to generate a Diffie-Hellman shared secret (or alternative), or to be directly used as an encryption key, to be exchange between the WTRU and the RAN node. This public key may be a single-use key, or it may be permanently stored at the WTRU. Also, it may include information on the length of the key exchanged.

For example, validityTime field may provide time information regarding the validity of the keys exchanged or on the maximum time that the Pre-registration security will be valid between the two peers.

For example, a Nonce may be a value or list of values, and may be required for some algorithms for shared key exchange.

For example, a message_seq_num field may be a value indicating the message sequence during the pre-registration security message exchange as part of this procedure.

For example, a result for the exchange may be an indication of security information exchange success.

A given implementation may send or set all OPTIONAL fields of a message and/or information element (IE) (e.g., the SBI-WTRU-security-IE), or a subset of them depending on the message sequence of the procedure, security requirements, configuration specifics, use case specifics, other parameters, and/or the requirements for a given network deployment. For example, a given implementation may employ three messages to exchange SBI WTRU RAN security information and may only acknowledge the status of the procedure in the third message exchange. For all messages including the SBI-WTRU-security-IE, the field message-seq-num may be the sequence number of the SBI WTRU RAN security frame (e.g., 1, 2, 3). On a different implementation, the sequence of the SBI WTRU RAN security message may be convened using the RRC-TransactionIdentifier field. Additionally, the result field of the SBI-WTRU-security-IE may indicate the success or failure of the procedure at any time. If at any point, one peer (e.g., WTRU or RAN node) declares in the result field as FAIL, the procedure may stop, restart, or trigger some other action outside of the procedure.

As shown in FIG. 15, there may be one or more actions for the enhanced WTRU Connection Establishment procedure to establish SBI WTRU access to the network with SBI WTRU RAN security. In this approach, there may be communication between the WTRU 1501 and an atomic RAN node 1502 (e.g., a stand-alone gNB). However, this approach may also imply a split RAN deployments (e.g., with a gNB-DU and gNB-CU, not shown).

Initially, it may be assumed that the WTRU is configured with sufficient information to establish a connection to the RAN node in the network. The WTRU may also be configured with sufficient information on network elements in the core network that it needs to interact via their SBI interfaces. Internal to the WTRU, the need for the WTRU to interact with one or more network elements via SBI access that requires connection establishment may have already been triggered. This procedure assumes that whatever triggered the procedure requires SBI WTRU RAN security.

Additionally/alternatively, at 1511, the WTRU may select a RAN node for SBI WTRU connection establishment, for example, using one or more techniques described herein.

Additionally/alternatively, at 1512, the WTRU may send an enhanced RRCSetupRequest message, as described herein, to the RAN node requesting SBI WTRU access with SBI RAN security by setting direct-sbi-access=TRUE and direct-sbi-access-sec=Sec, or Sec-HL-Sec in the case of SBI RAN security and SBI HL security.

Additionally/alternatively, at 1513, upon reception of the enhanced RRCSetupRequest from the WTRU, the RAN node may take note of the WTRU's request for direct SBI WTRU access with SBI RAN security. The RAN node may allocate a C-RNTI for the WTRU, create an RRC configuration, and/or configure radio bearers for the initial setup link without any security protection. In this case, the RAN node may send an enhanced RRCSetup message, as described herein, to the WTRU indicating its acceptance and willingness to setup SBI WTRU RAN security by setting direct-sbi-access-sec=Sec in the enhanced RRCSetup message, or Sec-HL-Sec in case of SBI WTRU RAN security and SBI WTRU HL security.

Additionally/alternatively, at 1514, after receiving the enhanced RRCSetup message from the RAN node, the WTRU may verify that SBI WTRU access with SBI WTRU RAN security is acceptable based on its configuration. The WTRU may respond with an enhanced RRCSetupComplete message, as described herein, to the RAN node. This may be similar to 814, for example: a dedicatedNAS-message may not be included; the registered AMF identifier may not be included; and/or, secureServer-SBI-WTRU may be set by the WTRU to inform the RAN node of any SBI WTRU access SGW.

The WTRU may include needed SBI WTRU RAN security information in the SBI-WTRU-security-container to start the configuration of SBI WTRU RAN security, including parameters to derive the shared key. There may be one or more parameters to be added to the SBI-WTRU-security-container for this message.

For example, there may be one or more parameter for information on the ciphering algorithm to be used, considering that new ciphering mechanisms may be needed for this purpose. Also, indication on the algorithm that may be used to compute message Integrity Codes. This information may be transported through the securityAlgorithmConfig field of the PreRegistration-security-IE.

For example, there may be one or more parameter needed to generate compatible public and private keys at the peer nodes, WTRU and RAN node. For example, if Finite Cyclic Groups are used, a common group may be used between the peers. This information may be transported through the preRegistrationParams field of the PreRegistration-security-IE.

For example, there may be one or more parameter for a public key to be used to generate a Diffie-Hellman (or alternative) shared secret, or to be directly used as encryption key, to be exchange between the WTRU and the RAN node. This public key may be single use, or it may be permanently stored at the WTRU. Also, information on the length of the key exchanged may be needed. This information may be transported through the preRegistrationPublicKey field of the PreRegistration-security-IE.

For example, there may be one or more parameter for timeout information regarding the validity of the keys exchanged or on the maximum time that the Pre-registration security will be valid between the two peers. This information may be transported through the validityTime field of the PreRegistration-security-IE.

For example, there may be one or more parameter for a Nonce value or list of values, which may be required for some algorithms for shared key exchange. This information may be transported through the nonce field of the PreRegistration-security-IE.

For example, there may be one or more parameter for a value indicating the message sequence on the Pre-Registration 2 or 3 message exchange. This information may be transported through the message_seq_num field of the PreRegistration-security-IE.

In the example of FIG. 15, it may be assumed that there are three messages to carry the SBI WTRU RAN security information, however, it is intended that in other cases there may be greater or fewer messages with varying configurations of what information is included in those messages (e.g., these messages may be a part of existing RRC messages, and may refer to the security container exchanges). The enhanced RRCSetupComplete may include the first of the SBI WTRU RAN security messages required to set the shared key. Therefore, at this point, there is no shared state that can be used for integrity protection.

Additionally/alternatively, at 1515, the RAN node may receive the enhanced RRCSetupComplete message and may install a new temporal reduced WTRU context (e.g., defined in Table 1) in the RAN Node to manage the WTRU's SBI communication. The RAN node may create the temporal reduced WTRU context (e.g., similar to 815).

However, unlike at 815, at 1515 the RAN node may derive a shared element (e.g., based on the public key, local private key, or other parameters exchanged) that may be used to generate a shared Key using the SBI-WTRU-security-container from the WTRU (e.g., message 1 in the SBI WTRU RAN security exchange) received at 1514. This shared Key may be stored in the Key Material field of the temporal reduced WTRU context.

Additionally/alternatively, at 1516, the RAN node may use an enhanced securitymodecommand RRC message to send the message 2 of the SBI WTRU RAN security exchange to the WTRU. The enhanced securitymodecommand may be modified to include the SBI-WTRU-security-container as shown below. The container may include the information required for the WTRU to derive the shared key, as in the previous enhanced RRCSetupComplete message, within a PreRegistration-security-IE.

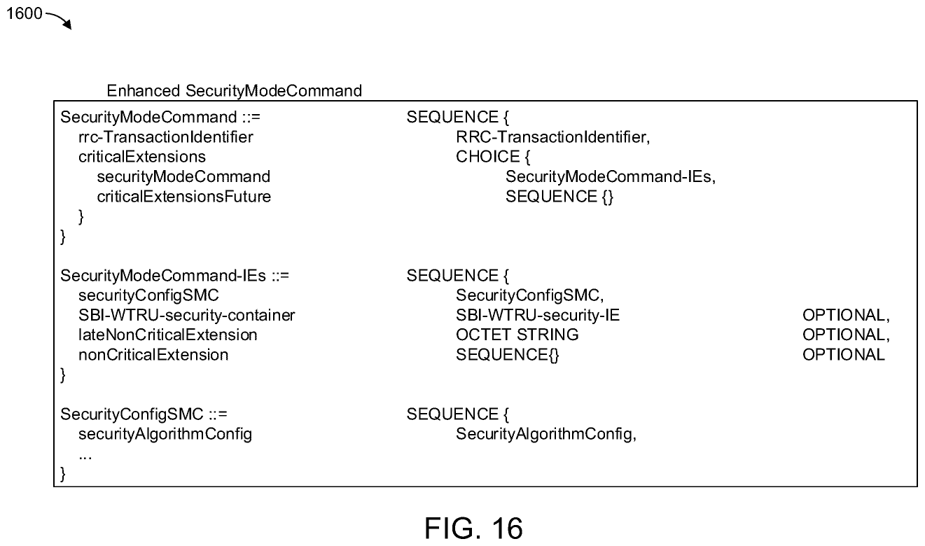

FIG. 16 illustrates an example of an enhanced securitymodecommand. The message shown is merely for illustration purposes, and a message used in the one or more procedures disclosed herein may not include one or more fields as shown (e.g., in order to reduce the size of the message) and/or may include one or more fields not shown (e.g., some other information disclosed herein). Aspects of the message may be based on legacy approaches, or the message may not be based on legacy approaches, and represent a new message relative to legacy approaches. As in previous messages, the modification may be implemented in a different IE or in a different way, as along as message 2 of the SBI WTRU RAN security exchange is included in the enhanced securitymodecommand message. Since the RAN Node has been able to derive a shared key at this point in the process, the enhanced securitymodecommand message may be integrity protected with the derived shared key. Finally, the securityAlgorithmConfig field in the message may be extended to consider the new algorithms required to enable cyphering and integrity protection on the RAN access link.

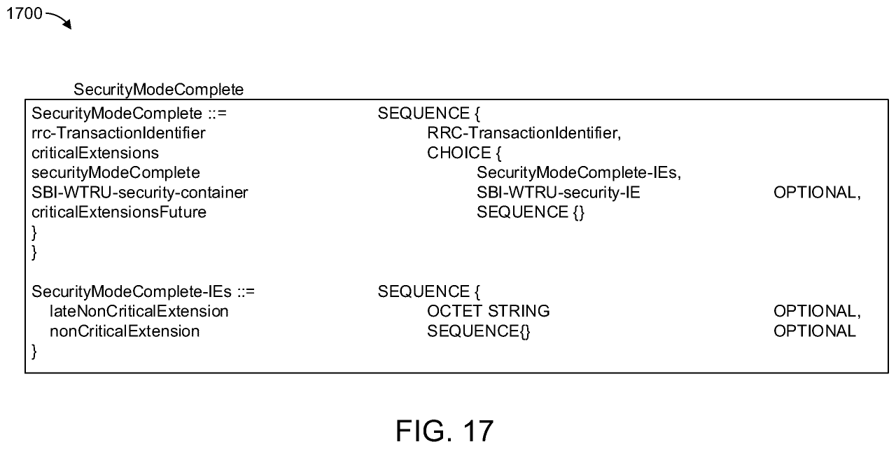

Additionally/alternatively, at 1517, the WTRU may use a SBI-WTRU-security-container carried in the enhanced securitymodecommand to derive a shared secret that may be used to derive a shared key. The mechanism used may be implementation independent, but may use the information carried in the SBI-WTRU-security-container, such the as securityAlgorithmConfig, preRegistrationParams, preRegistrationPublicKey, and/or nonce. The WTRU may respond with an enhanced securitymodecomplete message, shown in the example of FIG. 17. This message may act as acknowledgement of the previous securitymodecommand message from 1516; it may indicate to the RAN node the successful completion of the SBI WTRU RAN security configuration.

FIG. 17 illustrates an example of a securitymodecomplete. The message shown is merely for illustration purposes, and a message used in the one or more procedures disclosed herein may not include one or more fields as shown (e.g., in order to reduce the size of the message) and/or may include one or more fields not shown (e.g., some other information disclosed herein). Aspects of the message may be based on legacy approaches, or the message may not be based on legacy approaches, and represent a new message relative to legacy approaches. As in other message examples disclosed herein, the example message of FIG. 17 shows a specific implementation that may be implemented in a different IE or in a different way.

Returning to 1517, the RAN access link connection may be encrypted, and integrity protected using the derived shared key. All subsequent messages between the WTRU and RAN node may therefore be protected.

As an alternative, if the security configuration fails in the WTRU, the WTRU may send an enhanced securitymodeFailure message, which may include the SBI-WTRU-security-container, indicating the failure, or the WTRU may choose not to include it and simply indicate a general failure in the security setup.

Additionally/alternatively, at 1518, the RAN Node may configure the communication connection in the network for the WTRU to access network elements via SBI in the core network. The WTRU may use this connection to exchange SBI messages with network elements in the Core network. The RAN node may configure the control (SRB) or data (DRB) bearers to carry the SBI messages from the WTRU. Therefore, the WTRU may use a control channel to do so and may not need to setup a PDU session for SBI messages. The RAN node may assign an address (e.g., IP address, or other identifier), to the WTRU to enable the transfer of SBI messages with network elements in the core network. The address may be IPV4, IPv6, public or private, depending on deployment and implementation specific needs. The RAN node may store the SBI WTRU IP configuration information in the temporal reduced WTRU context for the WTRU. In one instance, the IP configuration information may include an IPV4 and/or IPV6 address, mask or prefix, and gateway (Dgw), or any applicable identifiers or addresses for SBI communication in the network.

Additionally/alternatively, at 1519, the RAN node may send an enhanced RRCReconfiguration to the WTRU to inform it of the SBI WTRU communication configuration created in 1518, including the SBI WTRU IP address assigned by the RAN node and the RAN access configuration (e.g., configuration for SRBs and/or DRBs).

In the enhanced RRCReconfiguration (e.g., FIG. 12), the RAN node may inform the WTRU of the control (SRB) or data (DRB) bearers to carry the SBI messages from the WTRU. This may be done by including the configuration in the radioBearerConfig parameter. Within this parameter (e.g., both cases, SRB or DRB configuration), the RAN node may include a pdcp-Config element (e.g., FIG. 13). In some cases, the configuration of parameters required for the SBI communication (e.g., as discussed herein), may be independent from the actual nature of the radio bearers. They may be independent from a radio bearer (RB) being for control signaling or data. Additionally, a generic radio bearer with the same parameters may work to configure and establish the SBI communication. The actual implementation of the parameters for SBI WTRU access configuration in the IEs of the enhanced RRCReconfiguration message may differ from what is described herein and/or shown. The information may be realized in different IEs depending on the implementation. The pdcp-Config information element within the RadioBearerConfig may indicate (e.g., by modifying existing formats) that the configured radio bearer should only be used for WTRU SBI messages.

Additionally/alternatively, at 1520, the WTRU may use the SBI WTRU access configuration information from the received enhanced RRCReconfiguration to configure its internal communication resources (e.g., SRB and/or DRB settings, etc.) and set its SBI WTRU IP configuration.

Additionally/alternatively, at 1521, the WTRU may respond to the RAN node with an RRCReconfigurationcomplete message to acknowledge that the SBI WTRU connection configuration is complete.

Following 1521 or 1520, the WTRU and RAN node may be sufficiently configured, with SBI WTRU RAN security, to exchange SBI WTRU messages between the WTRU and network elements in the core network.

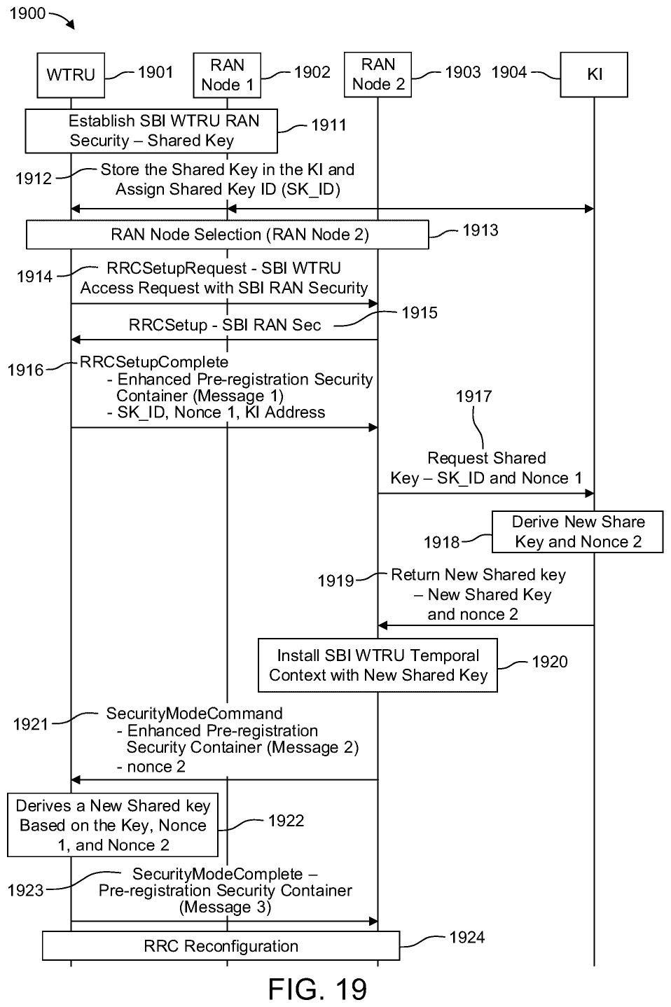

FIG. 19 illustrates an example of SBI WTRU connection establishment with SBI WTRU RAN security and key infrastructure. As shown, there may be a WTRU 1901, a first RAN Node 1901, a second RAN Node 1903, and a Key Infrastructure (KI) 1904.

In this approach, illustrated by example in FIG. 19, there may be enhances to the SBI WTRU connection establishment with SBI WTRU RAN security (e.g., as described herein) by storing derived SBI WTRU RAN security keys in a Key Infrastructure so they can be reused on later connection establishments by a WTRU to the same or different RAN node. This is to enable deployments that may be sensitive to connection establishment delay by reducing time to derive keys once the WTRU has established a connection with a previous RAN node.

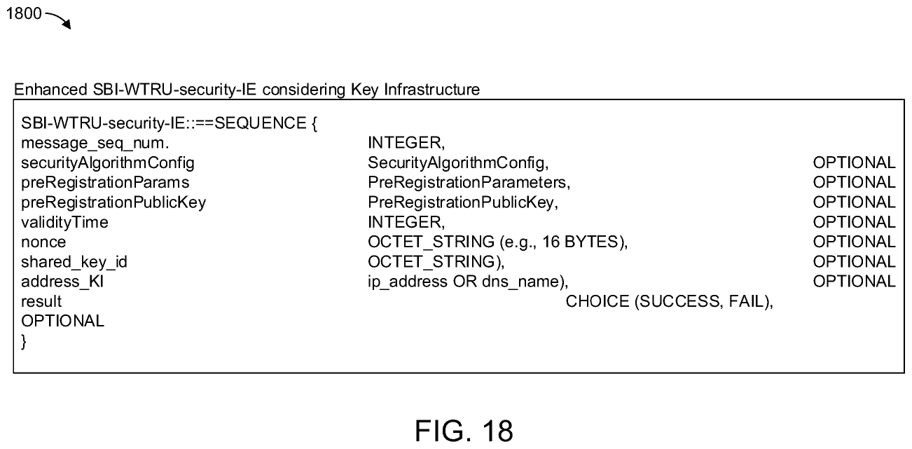

FIG. 18 illustrates an example of an enhanced SBI-WTRU-security IE considering KI. The IE shown is merely for illustration purposes, and an IE used in the one or more procedures disclosed herein may not include one or more fields as shown (e.g., order to reduce the size of the IE) and/or may include one or more fields not shown (e.g., some other field disclosed herein). Aspects of the IE may be based on legacy approaches, or the IE may not be based on legacy approaches, and represent a new IE relative to legacy approaches.

During a previously executed SBI WTRU connection establishment with SBI WTRU RAN security procedure, the WTRU and/or the RAN node may store the derived SBI WTRU RAN security in a Key Infrastructure (KI) (e.g., a network element, network function, network node, a Public Key Management Function (PKMF), etc. In an alternative, derived keys may be stored by the KI directly and then accessed by the WTRU or RAN node. To store and retrieve SBI WTRU RAN security key information with a KI, the SBI-WTRU-security-IE may be modified as shown in the example of FIG. 18. For purposes of this SBI communication scenario involving the KI, SBI-WTRU-security-IE may include: shared_key_id, which is the identifier of the shared key with the KI; and/or address_KI, which is the IP address, FQDN name, or any form of resource name used to communicate with the KI.

Initially, it may be assumed that the WTRU is configured with sufficient information to establish a connection to both RAN node 1 and RAN node 2 in the network. The WTRU may also be configured with sufficient information on network elements, or other services in the core network that it needs to interact with via their SBI interfaces. Both RAN Node 1 and RAN Node 2 may provide SBI connectivity to the network elements that the WTRU needs. In some cases, RAN Node 1 and RAN Node 2 may be the same entity.

Additionally/alternatively, at 1911, the WTRU and the RAN Node 1 may establish an SBI WTRU connection with SBI WTRU RAN security and have derived an associated shared key for communication with SBI WTRU RAN security (e.g., using one or more techniques described herein).

Additionally/alternatively, at 1912, once the WTRU and RAN Node 1 have derived a key at 1911, either the WTRU, RAN Node 1, or both may store the key credential information in a KI. The WTRU or RAN Node 1 may forward the shared key to the KI. To identify the stored key, it may be assigned a shared Key Identifier (SK_ID). In one instance, the SK_ID assignment may have been made by the KI at a previous time.

Additionally/alternatively, at 1913, the WTRU may select a RAN Node 2 (e.g., due to mobility reasons) for SBI WTRU connection establishment (e.g., using one or more techniques described herein). The WTRU may select this node for SBI WTRU connection while disconnected, while connected to the RAN Node 1 (e.g., for any reason) or any other RAN node (e.g., for any reason).

Additionally/alternatively, at 1914, the WTRU may send an enhanced RRCSetupRequest message to the RAN Node 2 requesting SBI WTRU access with SBI RAN security (e.g., similar to techniques described herein, such as 1512).

Additionally/alternatively, at 1915, the RAN Node 2 may respond with an enhanced RRCSetup message, indicating SBI WTRU access with SBI RAN security (e.g., similar to techniques described herein, such as 1513).

Additionally/alternatively, at 1916, after receiving the enhanced RRCSetup message from RAN Node 2, the WTRU may verify that SBI WTRU access with SBI WTRU RAN security is acceptable based on its configuration. The WTRU may respond with an enhanced RRCSetupComplete message (message 3 of the security exchange, FIG. 11) to RAN Node 2. The WTRU sets the enhanced RRCSetupComplete message (e.g., similar to techniques described herein, such as 1514). Additionally, the WTRU may configure the following additions within a SBI-WTRU-security-container in an enhanced SBI-WTRU-security-IE (e.g., FIG. 18) to perform SBI WTRU connection establishment with SBI WTRU RAN security and using a Key Infrastructure: shared_key_id, which is set to the SBI WTRU RAN shared security key (SK_ID 1) from 1912; address_KI, which is set to the address of the KI for the RAN Node 2 to derive a new shared key; and/or, nonce, which is set with the Nonce value(s) (e.g., nonce 1) to be used to derive a second, new shared key for SBI WTRU RAN security.

Additionally/alternatively, at 1917, after RAN Node 2 receives the enhanced RRCSetupComplete message, it may create and install a new temporal reduced WTRU context (e.g., similar to techniques described herein, such as 1515). However, RAN Node 2 does not independently derive the shared Key for SBI WTRU RAN security (e.g., as is done in FIG. 15). Alternatively, RAN Node 2 requests a new shared Key from the KI. The entry point to the KI may be identified by the KI address from the WTRU or by configuration of RAN Node 2. In the request for a new shared Key, RAN Node 2 forwards in the shared key identifier (SK_ID 1) and the Nonce values (nonce 1) received at 1916 from the WTRU to the KI.

Additionally/alternatively, at 1918, using the received SK_ID 1 and nonce 1, the KI may select new Nonce values (nonce 2) and derives a new shared key that can be used for SBI WTRU RAN security between the WTRU and RAN Node 2. KI derives the new key based on a shared key (e.g., associated with SK_ID 1), nonce 1, nonce 2, and any other relevant information. The KI may assign an identifier for the new shared key (SK_ID 2).

Additionally/alternatively, at 1919, the KI may respond to RAN Node 2's request in at 1917 with the new shared Key, the new shared key identifier (SK_ID 2), and new Nonce values (nonce 2). RAN Node 2 may store the received information in the temporal reduced WTRU context (Key Material) for the WTRU.

Additionally/alternatively, at 1920, the RAN Node 2 may send an enhanced securitymodecommand RRC message to the WTRU (e.g., similar to techniques described herein, such as 1516), however using the Enhanced SBI-WTRU-security-IE (e.g., FIG. 18), including the new shared key identifier (SK_ID 2), the KI address that generated the new shared key, and the new Nonce values (nonce 2).

Additionally/alternatively, at 1921, after receiving in the enhanced securitymodecommand message, the WTRU may derive a new shared key for SBI WTRU RAN security using the share key from earlier, nonce 1, and nonce 2 (e.g., from the Enhanced SBI-WTRU-security-IE in the enhanced securitymodecommand message). The WTRU may store SK_ID 2 and nonce 2 for future use (e.g., execution of this same procedure at a future time with the same or different RAN node).

Additionally/alternatively, at 1922, the WTRU may respond with an enhanced securitymodecomplete message (e.g., similar to techniques described herein, such as 1517).

The WTRU and RAN Node 2 may complete the RRC reconfiguration.

Additionally/alternatively, at 1923, the RAN Node 2 may configure the communication connection in the network for the WTRU to access network elements via SBI in the core network. The WTRU may use this connection to exchange SBI messages with network elements in the Core network. The RAN node 2 may configure the control (SRB) or data (DRB) bearers to carry the SBI messages from the WTRU. Therefore, the WTRU may use a control channel to do so and may not need to setup a PDU session for SBI messages. The RAN node 2 may assign an address (e.g., IP address, or other identifier), to the WTRU to enable the transfer of SBI messages with network elements in the core network. The address may be IPV4, IPv6, public or private, depending on deployment and implementation specific needs. The RAN node 2 may store the SBI WTRU IP configuration information in the temporal reduced WTRU context for the WTRU. In one instance, the IP configuration information may include an IPV4 and/or IPv6 address, mask or prefix, and gateway (Dgw), or any applicable identifiers or addresses for SBI communication in the network.

Additionally/alternatively, at 1924, the RAN node 2 may send an enhanced RRCReconfiguration to the WTRU to inform it of the SBI WTRU communication configuration created in 1923, including the SBI WTRU IP address assigned by the RAN node 2 and the RAN access configuration (e.g., configuration for SRBs and/or DRBs).

In the enhanced RRCReconfiguration (e.g., FIG. 13), the RAN node 2 may inform the WTRU of the control (SRB) or data (DRB) bearers to carry the SBI messages from the WTRU. This may be done by including the configuration in the radioBearerConfig parameter. Within this parameter (e.g., both cases, SRB or DRB configuration), the RAN node 2 may include a pdcp-Config element. In some cases, the configuration of parameters required for the SBI communication (e.g., as discussed herein), may be independent from the actual nature of the radio bearers. They may be independent from a radio bearer (RB) being for control signaling or data. Additionally, a generic radio bearer with the same parameters may work to configure and establish the SBI communication. The actual implementation of the parameters for SBI WTRU access configuration in the IEs of the enhanced RRCReconfiguration message may differ from what is described herein and/or shown. The information may be realized in different IEs depending on the implementation. The pdcp-Config information element within the RadioBearerConfig may indicate (e.g., by modifying existing formats) that the configured radio bearer should only be used for WTRU SBI messages.

Additionally/alternatively, at 1925, the WTRU may use the SBI WTRU access configuration information from the received enhanced RRCReconfiguration to configure its internal communication resources (e.g., SRB and/or DRB settings, etc.) and set its SBI WTRU IP configuration.

Additionally/alternatively, at 1926, the WTRU may respond to the RAN node 2 with an RRCReconfigurationcomplete message to acknowledge that the SBI WTRU connection configuration is complete.

Following 1925 or 1926, the WTRU and RAN node 2 may be sufficiently configured, with SBI WTRU RAN security, to exchange SBI WTRU messages between the WTRU and network elements in the core network.

In one case, there may be SBI Higher-layer secure SBI communication. This approach may use/establish a secure tunnel to exchange SBI message between the WTRU and elements in the network to provide SBI Higher Layer security for SBI WTRU communication via an SGW.

The WTRU may discover and select a RAN node for SBI WTRU access that supports SBI WTRU Higher Layer security. For example, selecting a RAN Node (e.g., using techniques described herein, such as FIG. 6) that indicates sbi-WTRU-HL-Sec in cellAccessRelatedInfo-SBI-WTRU system information (e.g., in SIB1).

The WTRU and RAN node may establish an SBI WTRU connection with or without SBI WTRU RAN security, using techniques described herein (e.g., FIG. 8 no SBI RAN security, FIG. 15 with SBI RAN security, or FIG. 19 with SBI RAN security—with KI).

The direct-sbi-access-sec field in any messages between the WTRU and RAN Node (enhanced RRCSetupRequest, enhanced RRCSetup, etc.) may be set as follows: No SBI WTRU RAN security, which is direct-sbi-access-sec=HL-Sec; and/or, SBI WTRU RAN security, which is direct-sbi-access-sec=Sec-HL-Sec.

After the RAN connection is established for SBI WTRU access and considering the negotiated security level (e.g., assuming SBI HL security is selected), the WTRU may establish a higher-layer secure tunnel (e.g., an IPSec tunnel) with the SGW, that is indicated in the secureServer-SBI-WTRU field of the enhanced RRCSetup message. Alternatively, the RAN node may establish a secure tunnel with the SGW and route SBI traffic from the WTRU through it without the WTRU establishing the tunnel.

After the higher-layer secure tunnel is established, the WTRU may execute SBI authentication (e.g., OAuth) and SBI security (e.g., TLS) with elements in the network (including the SGW or network elements directly) within the higher-layer secure tunnel.

The WTRU and the network elements in the core network may exchange SBI messages using the higher-layer secure tunnel (e.g., as described herein).

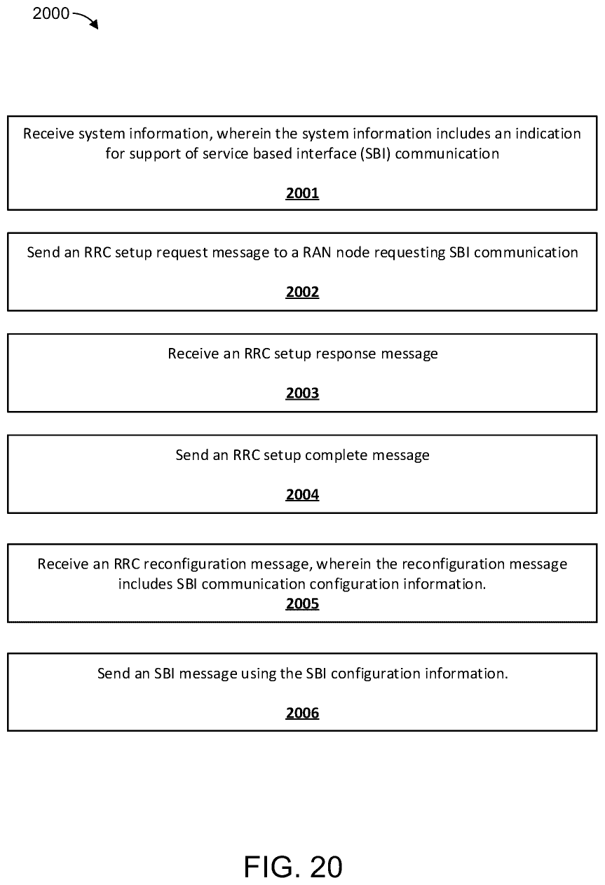

FIG. 20 illustrates an example method according to one or more techniques described herein. In this example, there may be a WTRU and one or more RAN nodes (e.g., base station, etc.). The WTRU may implement this method with, for example, one or more processors operatively coupled to one or more transceivers. At 2001, the WTRU may receive system information, wherein the system information may include an indication for support of service-based interface (SBI) communication. Additionally/alternatively, at 2002 the WTRU may send an RRC setup request message to a RAN node request SBI communication. Additionally/alternatively, at 2003 the WTRU may receive an RRC setup response message. Additionally/alternatively, at 2004 the WTRU may send an RRC setup complete message. Additionally/alternatively, at 2005 the WTRU may receive an RRC reconfiguration message, wherein the reconfiguration message include SBI may communication configuration information. Additionally/alternatively, at 2006 the WTRU may send an SBI message using the SBI configuration information. Additionally/alternatively, the system information may further include an indication of security for the SBI communication. Additionally/alternatively, the RRC setup request message may include an indication of security for the SBI communication. Additionally/alternatively, the SBI communication configuration information may include IP address information and/or radio bearer information for use in sending the SBI message.

In an example based on one or more techniques described herein, there may be a procedure for establishing service based interface communication. A WTRU may performing one or more actions in this example. A WTRU, while in a connected or unconnected state, receive directly SBI access capability information from one or more RAN nodes (e.g., base station, network node, element, function, etc.). Additionally/alternatively, the WTRU may select a RAN node for SBI access connection establishment, using the received capability information. Additionally/alternatively, the WTRU may establish an access connection to the selected RAN node for direct SBI access, depending on the RAN node's SBI WTRU access capability information and the WTRU's configuration. There may be two SBI RAN security options: Option #1—No SBI WTRU RAN security; Option #2—SBI WTRU RAN security. Additionally/alternatively, the WTRU may establish a secure tunnel with an SBI security gateway. All SBI traffic between the WTRU and network elements may be securely exchanged via this tunnel. Additionally/alternatively, the WTRU may establish an SBI security association with one or more SBI network elements. Additionally/alternatively, the WTRU may perform SBI authentication with one or more SBI network elements. Additionally/alternatively, the WTRU may communicate with SBI network elements via the established access connection with the configured security levels (e.g., No SBI WTRU RAN security, SBI WTRU RAN security, SBI WTRU Higher-layer security, SBI security, etc.).

In an example based on one or more techniques described herein, there may be a procedure for selecting a RAN node for direct SBI access via a WTRU. A WTRU may perform one or more in this example. A WTRU, while in a connected or unconnected state, may receive system information from a RAN node that includes information regarding direct SBI WTRU access capabilities available via the RAN node. Additionally/alternatively, the WTRU may select a RAN node for SBI WTRU access using the received direct SBI WTRU access capability information from one or more RAN nodes. Additionally/alternatively, the WTRU may establish a SBI WTRU connection to the selected RAN node using the received direct SBI WTRU Access capability information.

In an example based on one or more techniques described herein, a connection may be established with a WTRU without security. A RAN node (e.g., selected by the WTRU) may perform one or more action (e.g., as a counterpart to a WTRU). The RAN node may receive an RRC setup Request message from the WTRU that indicates the WTRU is requesting direct SBI WTRU Access with no security. Additionally/alternatively, the RAN node may create an RRC configuration and sends an RRC setup message to the WTRU, indicating direct SBI WTRU Access with no security. Additionally/alternatively, the RAN node may receive an RRC setup complete message from the WTRU indicating an SBI SGW configuration (e.g., without any NAS message or registered AMF). Since SBI RAN security ma not be used, the RRC setup complete message may not include any SBI WTRU Pre-Registration security IEs. Additionally/alternatively, the RAN node may create a SBI temporal reduced WTRU context for the WTRU, using the received information in the RRC setup complete message. Additionally/alternatively, the RAN node may send a security mode command message to the WTRU indicating no SBI WTRU RAN security. Additionally/alternatively, the RAN node may receive a security mode complete message from the WTRU. The WTRU security association with no SBI WTRU RAN security may be complete. Additionally/alternatively, the RAN node may configure the access network for SBI WTRU communication and assigns an IP address and/or other identifier, for the WTRU to use in SBI WTRU communication (e.g., storing it in the SBI temporal reduced WTRU context). Additionally/alternatively, the RAN node may send an RRC Reconfiguration message to the WTRU with the SBI WTRU Access communication configuration (e.g., including restricting traffic to SBI only) and the IP configuration for the WTRU to use in SBI interactions. Additionally/alternatively, the RAN node may receive an RRC Reconfiguration complete message that acknowledges that SBI WTRU connection configuration from the WTRU. SBI WTRU connection establishment without security may be complete.

In an example based on one or more techniques described herein, a connection may be established with a WTRU with security. This approach may be in addition to or in alternative to approaches without security, and/or any other process disclosed herein, with additional/alternative information exchanged and actions performed to establish an SBI WTRU connection with RAN security A RAN node (e.g., selected by the WTRU) may perform one or more action (e.g., as a counterpart to a WTRU). The RAN node may receive an RRC setup Request message from a WTRU that indicates the WTRU is requesting direct SBI WTRU Access with SBI WTRU RAN security. Additionally/alternatively, the RAN node may create an RRC configuration and sends an RRC setup message to the WTRU, indicating direct SBI WTRU Access with SBI WTRU RAN security. Additionally/alternatively, the RAN node may receive an RRC setup complete message from the WTRU (e.g., without any NAS message or registered AMF) that may include an SBI SGW configuration. Additionally, the RRC setup complete message may include an SBI WTRU security container the SBI WTRU Pre-Registration security information. Additionally/alternatively, the RAN node may derive a shared key for SBI WTRU RAN security using the received information, and create a SBI temporal reduced WTRU context for the WTRU using the received information, including storing the related SBI WTRU Pre-Registration security Information including the derived shared key. Additionally/alternatively, the RAN node may send a security mode command message to the WTRU including an SBI WTRU security container, which may include information for the WTRU to derive a matching shared key. Additionally/alternatively, the RAN node may receive a security mode complete message from the WTRU including an SBI WTRU security container that indicates successful completion of the SBI WTRU RAN security association. Additionally/alternatively, the RAN node may configure the access network for SBI WTRU communication and assigns an IP address (or other identifier) for the WTRU to use in SBI WTRU communication (storing it in the SBI temporal reduced WTRU context). Additionally/alternatively, the RAN node may send an RRC Configuration message to the WTRU including the SBI WTRU Access configuration.

In an example based on one or more techniques described herein, a connection may be established with a WTRU with security and key infrastructure (KI). This approach may be in addition to and/or in alternative to approaches with or without security. A WTRU may perform one or more in this example (e.g., as it interacts with one or more devices, such as a RAN node). The WTRU may store an SBI WTRU RAN security shared key, identified by a shared Key Identifier, in a Key Infrastructure (KI) network element. This share key is derived from a previous or current SBU WTRU security association with a RAN node. Additionally/alternatively, the WTRU may send an RRC setup Request message to a selected RAN node, requesting direct SBI WTRU Access with SBI WTRU RAN security. Additionally/alternatively, the WTRU may receive an RRC setup message from a RAN node, indicating direct SBI WTRU Access with SBI WTRU RAN security. Additionally/alternatively, the WTRU may send an RRC setup complete message to a RAN node with an SBI WTRU security container including a shared Key Identifier, address of the KI, and parameters that may be used by the RAN node or KI to derive a new shared key based on the identified shared key. Additionally/alternatively, the WTRU may receive a security mode command message from a RAN node including an SBI WTRU security container, including new shared key identifier, the KI address that generated the new shared key, and the parameters to derive a new shared key for the WTRU. Additionally/alternatively, the WTRU may derive a new shared key based on the received SBI WTRU security container. Additionally/alternatively, the WTRU may send with a security mode complete message the RAN node, including an SBI WTRU security container that indicates successful completion of the SBI WTRU RAN security association.

As described herein, a higher layer may refer to one or more layers in a protocol stack, or a specific sublayer within the protocol stack. The protocol stack may comprise of one or more layers in a WTRU or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non-Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

Although features and elements are described above in particular combinations (e.g., embodiments, methods, examples, etc.), one of ordinary skill in the art will appreciate that each feature or element can be used alone or in any combination with the other features and elements. For example, as disclosed herein there may be a method described in association with a figure for illustrative purposes, and one of ordinary skill in the art will appreciate that one or more features or elements from this method may be used alone or in combination with one or more features from another method described elsewhere. A symbol “/” (e.g., forward slash) may be used herein to represent ‘and/or’, where for example, ‘A/B’ may imply ‘A and/or B’. As used herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’ or indicate that something “does happen” or “can happen”. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

As disclosed herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. A symbol ‘/’ (e.g., forward slash) as used herein, unless otherwise indicated, represents ‘and/or’, where for example, ‘A/B’ may imply ‘A and/or B’.

As described herein, “etc.” may refer to etcetera, which is intended to reference any other like element in a list, or reference some other element disclosed herein. For example, if a list has “a, b, c, etc.” and another list disclosed herein discloses “a, b, c, d, e” then it is intended that the “etc.” may refer to at least “d, e” or “etc.” may generally refer to other letters in the alphabet.

As described herein, “at least one of” may be interchangeable with “one or more of”.

As described herein, reference of a configuration may mean that at some point a WTRU may receive a message that includes configuration information. In one instance, the WTRU may provide feedback after having received it. In one instance, the WTRU may request the message. In one instance, the message may be unrequested.

What is claimed:

1. A method implemented by a wireless transmit receive unit (WTRU), method comprising:
receiving system information, wherein the system information includes an indication for support of service-based interface (SBI) communication;
sending an RRC setup request message to a RAN node requesting SBI communication;
receiving an RRC setup response message;
sending an RRC setup complete message;
receiving an RRC reconfiguration message, wherein the RRC reconfiguration message includes SBI communication configuration information; and
sending an SBI message using the SBI configuration information.

2. The method of claim 1, wherein the system information further includes an indication of security for the SBI communication.

3. The method of claim 1, wherein the RRC setup request or the RRC setup response message includes an indication of security for the SBI communication.

4. The method of claim 1, wherein the SBI communication configuration information includes IP address information and/or radio bearer information for use in sending the SBI message.

5. The method of claim 1, prior to sending the RRC setup request, further comprising selecting the RAN node out of a plurality of RAN nodes that sent the system information.

6. The method of claim 1, prior to sending the RRC setup request, further comprising receiving a shared key for use in sending the RRC setup complete message.

7. The method of claim 1, further comprising sending a security mode command prior to receiving the RRC reconfiguration message.

8. A wireless transmit receive unit (WTRU) comprising:
a processor operatively coupled to a transceiver, the processor and transceiver configured to receive system information, wherein the system information includes an indication for support of service-based interface (SBI) communication;
the processor and transceiver configured to send an RRC setup request message to a RAN node requesting SBI communication;
the processor and transceiver configured to receive an RRC setup response message;
the processor and transceiver configured to send an RRC setup complete message;
the processor and transceiver configured to receive an RRC reconfiguration message, wherein the RRC reconfiguration message includes SBI communication configuration information; and
the processor and transceiver configured to send an SBI message using the SBI configuration information.

9. The WTRU of claim 8, wherein the system information further includes an indication of security for the SBI communication.

10. The WTRU of claim 8, wherein the RRC setup request or the RRC setup response message includes an indication of security for the SBI communication.

11. The WTRU of claim 8, wherein the SBI communication configuration information includes IP address information and/or radio bearer information for use in sending the SBI message.

12. The WTRU of claim 8, wherein, prior to sending the RRC setup request, the processor and transceiver are configured to send selecting the RAN node out of a plurality of RAN nodes that sent the system information.

13. The WTRU of claim 8, wherein, prior to sending the RRC setup request, the processor and transceiver are configured to receive a shared key for use in sending the RRC setup complete message.

14. The WTRU of claim 8, wherein the processor and transceiver are configured to send a security mode command prior to receiving the RRC reconfiguration message.
